(19) United States
(12) Patent Application Publication
(10) Pub. No.: US 2022/0292162 A1
(43) Pub. Date: Sep. 15, 2022

(54) INFORMATION PROCESSING DEVICE, INFORMATION PROCESSING METHOD, AND NON-TRANSITORY COMPUTER-READABLE MEDIUM STORING PROGRAM

(71) Applicant: NEC Corporation, Minato-ku, Tokyo (JP)

(72) Inventors: Shota MOTOURA, Tokyo (JP); Takashi MARUYAMA, Tokyo (JP)

(73) Assignee: NEC Corporation, Minato-ku, Tokyo (JP)

(21) Appl. No.: 17/631,969

(22) PCT Filed: Aug. 9, 2019
(86) PCT No.: PCT/JP2019/031718

§ 371 Date: Feb. 1, 2022

(51) Int. Cl. G06F 17/13

(52) U.S. Cl. CPC G06F 17/13; G06F 17/17

(57) ABSTRACT

To provide an information processing device capable of surely calculating, from at least one of the known value of a conditional probability and a mutual relation of conditional probabilities, the range of values that designated conditional probabilities can take. The information processing device (500) includes a converting unit (510) and a calculating unit (520). The converting unit (510) converts conditional probabilities, which are the calculation target of the range of values that can be taken, into real number variables. The calculating unit (520) calculates, using, as constraint conditions, the real number first-order formula group obtained by converting a first set of first-order formulas and a second set of first-order formulas, the range of values that the converted real number variables can take.

### TECHNICAL FIELD

The present invention relates to an information processing device, an information processing method, and a non-transitory computer-readable medium storing a program.

### BACKGROUND ART

Non Patent Literature 1 discloses a method of calculating a probability of an event described in a propositional formula. In Non Patent Literature 1, it is assumed that the number of propositional variables to be treated is a finite number. About several propositional formulas configured from these propositional variables, when an upper limit and a lower limit of values of occurrence probabilities of events represented by the propositional formulas are known, a problem of calculating an upper limit and a lower limit of values that an occurrence probability of an event of a designated propositional formula can take is solved.

### CITATION LIST

### Non Patent Literature

Non Patent Literature 1: Theodore Hailperin, “Best Possible Inequalities for the Probability of a Logical Function of Events”, “The American Mathematical Monthly”, Vol. 72, No. 4, Taylor & Francis, April 1965, pp. 343-359
Non Patent Literature 2: Jean H. Gallier, “Logic for Computer Science: Foundations of Automatic Theorem Proving”, Dover Publications, Second Edition Republished, 2015
Non Patent Literature 3: Karls Popper, “The Logic of Scientific Discovery”, Routledge, Second Edition, 2002, pp. 329-355

### SUMMARY OF INVENTION

### Technical Problem

However, the method according to Non Patent Literature 1 does not assume calculation of a range of values that a conditional probability can take. Therefore, in the method according to Non Patent Literature 1, it is likely that a range of values that conditional probabilities between events represented by the designated propositional formulas can take cannot be calculated.

In view of the problem described above, an object of the present disclosure is to provide an information processing device, an information processing method, and a program capable of surely calculating, from at least one of the known value of a conditional probability and a mutual relation of conditional probabilities, the range of values that designated conditional probabilities can take.

### Solution to Problem

An information processing device according to the present disclosure includes: converting means for converting conditional probabilities, the range of values which can be taken is a calculation target, into real number variables; and calculating means for calculating, using, as a constraint condition, a first-order formulas for the real numbers obtained by converting a first set of first-order formula for characterizing a function that receives two sets of propositional formulas and returns a conditional probability between two events represented by the two sets and a second set of first-order formulas each of which represents at least one of the known value of a conditional probability and a mutual relation of conditional probabilities, the range of values that the real number variables can take.

An information processing method according to the present disclosure includes: converting conditional probabilities, the range of values which can be taken is a calculation target, into real number variables; and calculating, using, as a constraint condition, a first-order formulas for the real numbers obtained by converting a first set of first-order formulas for characterizing a function that receives two sets of propositional formulas and returns a conditional probability between two events represented by the two sets and a second set of first-order formulas each of which represents at least one of the known value of a conditional probability and a mutual relation of conditional probabilities, the range of values that the real number variables can take.

A program according to the present disclosure causes a computer to execute: processing for converting a conditional probabilities, the range of values which can be taken is a calculation target, into real number variables; and processing for calculating, using, as a constraint condition, a first-order formulas for the real numbers obtained by converting a first set of first-order formulas for characterizing a function that receives two sets of propositional formulas and returns a conditional probability between two events represented by the two sets and a second set of first-order formulas each of which represents at least one of the known value of a conditional probability and a mutual relation of conditional probabilities, the range of values that the real number variables can take.

### Advantageous Effects of Invention

According to the present disclosure, it is possible to provide an information processing device, an information processing method, and a program capable of surely calculating, from at least one of the known value of a conditional probability and a mutual relation of conditional probabilities, the range of values that designated conditional probabilities can take.

### BRIEF DESCRIPTION OF THE DRAWINGS

FIG. 1 is a block diagram showing an information processing system according to a first example embodiment.

FIG. 2A is a flowchart showing the operation of the information processing system according to the first example embodiment.

FIG. 2B is a flowchart showing the operation of the information processing system according to the first example embodiment.

FIG. 3 is a block diagram showing an information processing system according to a specific example of the first example embodiment.

FIG. 4A is a flowchart showing the operation of the information processing system according to the specific example of the first example embodiment.

FIG. 4B is a flowchart showing the operation of the information processing system according to the specific example of the first example embodiment.

FIG. 5 is a diagram illustrating a determination result displayed by an output device according to the specific example of the first example embodiment.

FIG. 6 is a block diagram showing an information processing system according to a second example embodiment.

FIG. 7 is a flowchart showing the operation of the information processing system according to the second example embodiment.

FIG. 8 is a block diagram showing an information processing system according to a third example embodiment.

FIG. 9 is a flowchart showing the operation of the information processing system according to the third example embodiment.

FIG. 10 is a diagram illustrating an approximation graph according to the third example embodiment.

FIG. 11 is a diagram showing a modification of a calculating unit according to the third example embodiment.

FIG. 12 is a diagram showing an information processing device according to a fourth example embodiment.

FIG. 13 is a flowchart showing an information processing method executed by the information processing device according to the fourth example embodiment.

### DESCRIPTION OF EMBODIMENTS

### [Overview of Example Embodiments According to the Present Disclosure]

Prior to explanation of example embodiments of the present disclosure, an overview of the example embodiments according to the present disclosure is explained. In the following explanation, it is assumed that “probability” and “conditional probability” are respectively a probability and a conditional probability having a propositional formula as an argument. A probability without a condition (hereinafter, “unconditional probability”) can be regarded as a special case of a conditional probability (P(A)=P(A|True)). Therefore, in the following explanation, the concept of conditional probability includes the concept of the unconditional probability.

### (Assumption)

In the present disclosure, it is assumed that the number of propositional variables to be treated is finite. This assumption can be an assumption necessary for the present disclosure to have greater effects.

(Explanation about a Background Art)

The problem to be solved by the method according to Non Patent Literature 1 is formulated as follows.

X1, . . . , and Xn are assumed to be all propositional variables. At this time, it is assumed that, to several logical formulas Ai (i=1, . . . , 1), an upper limit ai and a lower limit bi of an occurrence probability P(Ai) (that is, ai≤P(Ai)≤bi) of events represented by the logical formulas are given. At this time, it is conceived that the maximum value and the minimum value of values that the occurrence probability P(B) of an event represented by an arbitrarily designated propositional formula B can take are calculated.

A solving method proposed in Non Patent Literature 1 is explained using an example. Assuming that the propositional variables are only X1=X and X2=Y and the case of A1=X, A2=Y, a1≤P(X)≤b1, a2≤P(Y)≤b2, and B=XΛY is conceived. “Λ (which is used instead of ‘∧’)” is the symbol indicating a conjunction. First, a logical formula is described using disjunctions (the symbol is “∨”) of XΛY, XΛ¬Y, ¬XΛY, and ¬XΛ¬Y. At this time, X and Y are respectively described as (XΛY)∨(XΛ¬Y) and (XΛY)∨(¬XΛY). Further using this, the occurrence probabilities of X and Y are, respectively, subdivided as P(X)=P(XΛY)+P(XΛ¬Y) and P(Y)=P(XΛY)+P(¬XΛY), where P(XΛY), P(XΛ¬Y), P(XΛY), and P(¬XΛ¬Y) are regarded as variables. Then, the problem to be solved is resulted in the linear programming problem explained below.

The maximum value and the minimum value of P(B)=P(XΛY) are calculated under the following constraint conditions: a1≤P(XΛY)+P(XΛ¬Y)≤b1 and a2≤P(XΛY)+P(¬XΛY)≤b2 and P(XΛY)≥0 and P(¬XΛY)≥0 and P(XΛ¬Y)≥0 and P(¬XΛ¬Y)≥0 and P(XΛY)+P(¬XΛY)+P(XΛ¬Y)+P(¬XΛ¬Y)=1.

When this linear programming problem is solved, the maximum value and the minimum value of values that P(B) can take are calculated. Note that the constraint condition that “values that variable can take are non-negative” and the constraint condition that “a sum is one” are conditions for enabling P to be regarded as a function for giving a probability.

(Explanation about a Problem to be Solved by the Present Disclosure)

The method according to Non Patent Literature 1 cannot be expanded to calculation of the range that a conditional probability can take. A counterexample is explained below.

As explained above, the propositional variables are represented as X1=X and X2=Y. At this time, the input form is expanded to a conditional probability. P(X|Y)=½ (that is, ½≤P(X|Y)≤½) and ½≤P(Y) (that is, ½≤P(Y)≤1) are inputs.

It is conceived that a probability that can be designated as a probability desired to be calculated is also expanded to a conditional probability and the conditional probability P(X|Y) is recalculated. Then, first, the inputs are equivalently converted into P(XΛY)=½P(Y) and ½≤P(Y) using unconditional probabilities at the input time. Note that, in the disclosed matter itself of Non Patent Literature 1, a condition such as P(XΛY)=½P(Y) is not allowed as an input; however, by adding the equivalent expression P(XΛY)=½(P(XΛY)+P(¬XΛY)) as a constraint condition of a linear programming problem, an unconditional probability satisfying this condition as well can be calculated.

In this example, the ranges of values that probabilities of P(XΛY) and P(Y), which are unconditional probabilities, can take are, respectively, ¼≤P(XΛY)≤½ and ½≤P(Y)≤1. Therefore, the upper limit of P(X|Y)=P(XΛY)/P(Y) is min{(the maximum value of P(XΛY))/(the minimum value of P(Y)), 1}=min{1, 1}=1. Similarly, the lower limit of P(X|Y)=P(XΛY)/P(Y) is max{(a minimum value of P(XΛY))/(a maximum value of P(Y)), 0}=¼. However, this does not coincide with the input P(X|Y)=½ (that is, ½≤P(X|Y)≤½). On the other hand, as explained below, this disclosure is configured to be able to solve such a problem.

### Definitions

Several terms used in the explanation in the example embodiments of the present disclosure are defined below.

“Propositional formula” is defined using a mathematical inductive method as explained below from a set of symbols, called propositional variables. That is, the propositional variables are propositional formulas. Negation ¬A of a propositional formula A is also a propositional formula. A conjunction AΛB of the propositional formulas A and B is also a propositional formulas. Only formulas configured from the above are propositional formulas. Note that, in the following explanation, a disjunction A∧B and an implication A→B are respectively regarded as abbreviations of ¬(¬AΛ¬B) and ¬(AΛ¬B).

The set of all propositional formulas regarded as an algebraic system is called a formula algebra. The “formula algebra” is the triple of (FORM, NOT, AND). FORM is the set of all propositional formulas. NOT is a function from FORM to FORM and is defined by NOT(A)=¬A. AND is a function from the direct product FORM×FORM to FORM and is defined by AND(A, B)=AΛB.

Further, the algebra obtained from the formula algebra by identifying logically equivalent logical formulas such as A and ¬¬A is called the Lindenbaum-Tarski algebra and defined as follows. That is, the “Lindenbaum-Tarski algebra” is defined by a set of (FORM/⇔, NOT′, AND′). “FORM/⇔” is the quotient set of the set of all logical formulas by the logical equivalence relation ⇔, that is, “=[A]|A∈FORM)”. Here, [A] represents {B|A⇔B}. For example, since ¬¬A (=B) is logically equivalent to A (that is, A⇔¬¬A), ¬¬A (=B) is an element of [A]. In contrast, since ¬A (=B) is not logically equivalent to A, ¬A (=B) is not an element of [A]. “NOT′” and “AND′” are algebraic operations on this quotient set FORM/⇔ and are, respectively, defined by NOT′([A])=[¬A] and AND′([A], [B])=[AΛB]. Note that, as explained above, since it is assumed that the number of propositional variables to be treated is finite, the number of elements of the Lindenbaum-Tarski algebra is also finite. This fact is used in the following explanation as well.

In this example embodiment, at least one of a value of a conditional probability having a propositional formula as an argument and a mutual relation of conditional probabilities is described in a first-order formula. Therefore, in this example embodiment, the first-order formula is formed in a kind of a two-layered structure of a logical formula concerning a logical formula. For example, about any propositional formulas x and y, the sum of the probability of x conditioned by y and the probability of ¬x conditioned by y being equal to one is described as “(∀ x:form) (∀ y:form) (P(x|y)+P(¬x|y)=1)”. This description form is more strictly defined as follows as a specific example of a language of many-sorted first-order predicate logic. Note that the following definition is configured by being partially changed based on pp. 432-434 of Non Patent Literature 2 describing a generalized (abstracted) definition of a many-sorted logic.

In this example embodiment, “first-order formula” is a many-sorted first-order predicate logic having a sort “form” of a propositional formula and a sort “real” of a real number, as sorts. Note that “sort” means a kind. A constant symbol of the form is a propositional formula. Function symbols (other than the constant symbols) concerning only the form are “not” and “and”, respectively, matched to the functions NOT and AND of the formula algebra of the propositional logic. A predicate symbol is only an equality sign “=”. However, in the following explanation, not(A) and and(A, B) can be respectively described as “¬A” and “AΛB”. The constant symbols of the real are “0” and “1”. The function symbols (other than the constant symbols) concerning only the real are “+” and “−” (a product sign is sometimes omitted) respectively corresponding to a sum and a product. Predicate symbols are an equality sign “=” and an inequality sign “≤”.

Logical formulas including integers other than 0 and 1 and the inverses of the integers and rational numbers are regarded as abbreviated notations of appropriate logical formulas. In the following explanation, a first-order formula configured based on the constant symbols, the function symbols, and the predicate symbols of the real is referred to as “real number first-order formula” or simply as “real number formula”. A function symbol concerning the sorts of both of the form and the real is only a symbol p representing a function for giving a conditional probability to a pair of two propositional formulas. When the two propositional formulas are described as A and B, the symbol p is described as p(A|B). Note that a predicate symbol concerning both of the sorts is not treated. Note that P(AB) represents a probability value but p(A|B) represents a string of symbols. Further, p(A|B) having the propositional formulas A and B as arguments in this way is referred to as “closed term representing a conditional probability”.

About logical connectives, like the definition of the propositional formula, only “A“and”,” are considered and the other logical connectives are regarded as abbreviations. About quantifiers, only present quantifiers about the respective form and real are considered and respectively described with sorts attached thereto like “(∃ form:x)” and “(∃ real:x)”. Note that universal quantifiers “(∀ form:x)” and “(∀ real:x)” are respectively abbreviations of “¬(∃ form:x)¬” and “¬(∃ real:x)¬”. Note that, when it is clear from a context, the sorts of the quantifiers are omitted and the quantifiers are sometimes simply written as “∀” “∃”. Parentheses [,] and (, ) are used as appropriate as supplementary symbols for easiness to read.

In this example embodiment, among the first-order formulas defined above, the first-order formula in which the terms of the form appear only as the argument of p is referred to as a “logical formula of a conditional probability”. Therefore, (∃ x:form)x=x is not the logical formula of the conditional probability. On the other hand, (∃ x:form)p(x|x)=1 is a logical formula of the conditional probability.

In the following explanation, conversion (mapping) of a logical formula is defined by “mathematical induction on the configuration of a logical formula”. This is a method of defining a conversion destination of a logical formula as a conversion destination of the subformulas of the logical formula. For example, mapping Φ from a propositional formula to a real number is defined by giving a clause to each constituent step of the propositional formula as explained below.

Φ(X)=1 (X is a propositional variable),

Φ(AΛB)=Φ(A)×Φ(B) (A and B are propositional formulas), and

Φ(¬A)=1−Φ(A) (A is a propositional formula).

When mapping from a logical formula to a logical formula is defined, the mapping is described as “converted in the homomorphic manner”. The following clauses are sometimes omitted.

About a variable symbol x, Ψ(x)=x,

with respect to a function symbol f including a constant symbol, Ψ(f(t1, . . . , tn))=f(Ψ(t1), . . . , Ψ(tn)) (t1, . . . , tn are terms),

with respect to a predicate symbol R, Ψ(f(t1, . . . , tn))=R(Ψ(t1), . . . , Ψ(tn)) (t1, . . . , tn are terms),

with respect to a logical connective Λ, Ψ(φΛψ)=Ψ(φ)ΛΨ(ψ) (φ and ψ are logical formulas),

with respect to a logical connective ¬, Ψ(¬φ)=¬Ψ(φ) (φ is a logical formula), and

with respect to a quantifier ∃ x:sort, Ψ((∃ x:sort)φ)=(∃ x:sort)Ψ(φ)(sort∈{form, real}) (φ is a logical formula).

Note that in the above definitions of “propositional formula” and “logical formula of the first-order logic”, the selection of “which symbol is incorporated in the definitions and which symbol is considered an abbreviation” is selection purely for explanation and does not limit an application range of the present disclosure.

### [Explanation of the Embodiments]

The example embodiments of the present disclosure are explained in detail below with reference to the drawings.

### First Example Embodiment

### (Explanation of a Configuration)

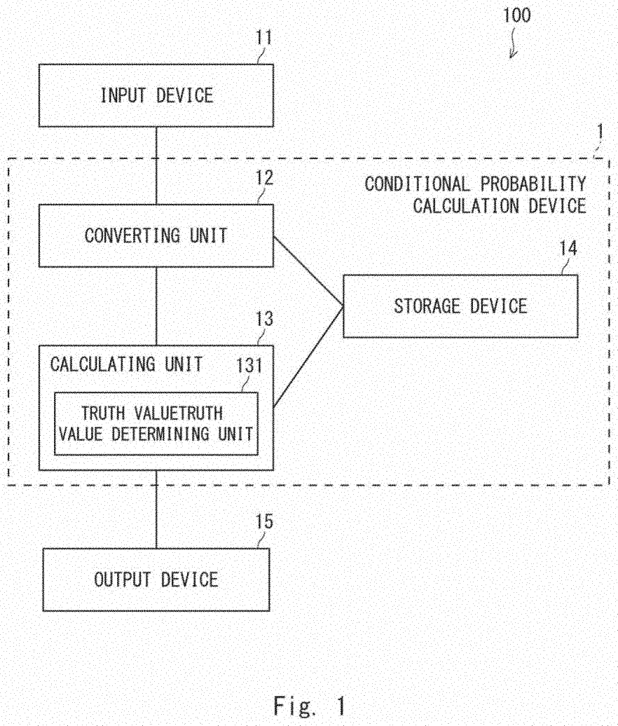

FIG. 1 is a block diagram showing an information processing system 100 according to a first example embodiment. As shown in FIG. 1, the information processing system 100 according to the first example embodiment includes a conditional probability calculation device 1, an input device 11, and an output device 15. The conditional probability calculation device 1 according to the first example embodiment includes a converting unit 12, a calculating unit 13, and a storage device 14. The converting unit 12 is connected to the input device 11, the calculating unit 13, and the storage device 14. The calculating unit 13 is connected to the converting unit 12, the storage device 14, and the output device 15. The calculating unit 13 includes a truth value determining unit 131.

The conditional probability calculation device 1 functions as an information processing device. That is, the conditional probability calculation device 1 can be realized by a computer. The input device 11 is an input device such as a keyboard, a mouse, or a touch panel. The output device 15 is an output device such as a display or a printing device. Note that the input device 11 and the output device 15 may be physically integrally configured as an input and output device. At least one of the input device 11 and the output device 15 may be configured physically integrally with the conditional probability calculation device 1. For example, the computer (an information processing device) realizing the conditional probability calculation device 1 may include the input device 11 and the output device 15. Similarly, the information processing system 100 can be realized by one or a plurality of computers.

Information included in the storage device 14 is explained below.

The storage device 14 stores a set of conditional probability logical formulas characterizing a conditional probability function (hereinafter referred to as “the conditional probability definition formulas”). The “conditional probability definition formulas” is conditional probability logical formulas characterizing a function (a conditional probability function) for receiving a pair of propositional formulas and returning the conditional probability between events represented by the pair. The “conditional probability definition formula” is like, for example, a logical formula (∀ x:form)(∀ y:form)P(x|x)=P(y|y). Note that this logical formula means that “the probability that x occurs in the case of x and the probability that y occurs in the case of y are equal with respect to any propositional formulas x and y (actually, it is proved that both of these probabilities are 1 and are equal).

The storage device 14 stores conditional probability logical formulas representing probability information (hereinafter simply referred to as “probability information”) concerning an application target (hereinafter referred to as “logical formulas representing probability information”). A “logical formulas representing probability information” is a conditional probability logical formula representing at least one of the known value of a conditional probability and a mutual relation of conditional probabilities. For example, when a “cancer diagnosis” is an application target of this example embodiment, the storage device 14 stores “p(cancer|lung cancer)=1” representing information indicating that “lung cancer is cancer”.

The storage device 14 stores all propositional variables considered as constituent elements of a propositional formula of an argument of a conditional probability. As explained above, the number of propositional variables is finite. Further, the storage device 14 stores a natural number (not including 0) N. The inverse of N is evaluation accuracy of a conditional probability. For example, when N=100, an evaluation result can be described using a percentage.

The components of the information processing system 100 according to the first example embodiment respectively operates as follows. The input device 11 receives, for example, according to operation of a user, closed terms p(Ai|Bi) (i=1, . . . , I) representing conditional probabilities. The converting unit 12 converts a closed term representing a conditional probability and a conditional probability logical formula. Since this conversion is related to the idea of Non Patent Literature 1, the conversion is explained along the idea of Non Patent Literature 1.

The input closed terms p(Ai|Bi) (i=1, . . . , I) representing conditional probabilities are converted into a variable V([Ai]|[Bi]) (i=1, . . . , I). Here, “([Ai]|[Bi]) plays a role of a suffix. Entire “V([Ai]|[Bi])” represents one variable. [A] is element of a Lindenbaum-Tarski algebra including A. However, this Lindenbaum-Tarski algebra is the Lindenbaum-Tarski algebra obtained by identifying logically equivalent logical formulas from all the propositional formulas constructed from the propositional variables stored in the storage device 14. In Non Patent Literature 1, processing of the identification is realized in a way of associating any logical formula with disjunctions of XΛY, XΛ¬Y, ¬XΛY, and ¬XΛ¬Y. The conversion into a variable is realized by regarding P(XΛY), P(XΛ¬Y), P(¬XΛY), and P(¬XΛ¬Y) as variables of the linear programming problem.

In Non Patent Literature 1, the conditional probability definition formulas are equivalent to a condition that variables should satisfy in order to regard allocations of real numbers to the variables as probability values (conditional probabilities). That is, the conditional probability definition formulas are equivalent to a constraint condition that a taken value is nonnegative (P(XΛY)≥0 or the like), a constraint condition that the sum is 1 (P(XΛY)+P(XΛ¬Y)+P(¬XΛY)+P(¬XΛ¬Y)=1), or the like. The converting unit 12 according to this example embodiment converts the conditional probability definition formulas to be “a condition for regarding allocation of real numbers to the variables as conditional probabilities” by performing processing for, for example, eliminating the quantifiers in the conditional probability definition formulas.

For example, (∀ x:form)(∀ y:form)P(x|x)=P(y|y) is converted into the following using an element of the Lindenbaum-Tarski algebra L:

$$\begin{matrix}[ Math . 1 ] & \\ {∧}_{( [ A ] , [ B ] ) ∈ L \times L} V ( [ A ] \vert [ A ] ) = V ( [ B ] \vert [ B ] ) & ( 1 )\end{matrix}$$

Consequently, the quantifier is eliminated, and p(x|x) and p(y|y) are, respectively, replaced with real number variables V([A]|[A]) and V([B]|[B]). Consequently, the conditional probability definition formulas as a whole is enabled to be regarded as conditioning formulas concerning the real number variables V([A]|[A]) and V([B]|[B]). The converting unit 12 performs such conversion by eliminating the quantifiers from the conditional probability definition formulas.

The logical formula representing probability information corresponds to a1≤P(X)≤b1 or a2≤P(Y)≤b2 representing the upper limit and the lower limit in Non Patent Literature 1. In the method of Non Patent Literature 1, in order to regard the upper limit and the lower limit as constraint conditions for the variables P(XΛY), P(XΛ¬Y), P(¬XΛY), and P(¬XΛ¬Y), the upper limit and the lower limit are rewritten as a1≤P(XΛY)+P(XΛ¬Y)≤b1 or a2≤P(XΛY)+P(¬XΛY)≤b2. Similarly to this, the converting unit 12 converts a logical formula representing probability information to be able to be regarded as a constraint condition of variables such as the variable V([A]|[B]). For example, p(cancer|lung cancer)=1 is converted into V([cancer]|[lung cancer])=1. Note that, in the case of Non Patent Literature 1, only the upper limit and the lower limit are treated. However, the converting unit 12 can also convert a conditional probability logical formula including a higher-degree equation or a quantifier.

The calculating unit 13 calculates the range of values that a variable group V([Ai]|[Bi]) (i=1, . . . , I) obtained by the converting unit 12 converting closed terms representing input probabilities can take at the time when the relational expression obtained by the converting unit 12 converting the conditional probability definition formulas and logical formulas representing probability information is set as constraint conditions. This corresponds to solving the linear programming problem in Non Patent Literature 1.

However, problems treated in this example embodiment are not limited to linear programming problems. As explained below, as an example of the conditional probability definition formula, there is a formula (∀ x:form)(∀ y:form)(∀ z:form)(p(xΛy|z)=p(x|yΛz)p(y|z) (see p. 337 of Non Patent Literature 3). In this formula, the right side is a quadratic term. Note that this formula is equivalent to generalization of the definition of conditional probability based on a well-known nonconditional probability. Actually, when a common precondition z is omitted, P(xΛy)=P(x|y)P(y) is obtained. When both the sides are divided by P(y), P(xΛy)/P(y)=P(x|y) is obtained.

Further, when this formula is repeatedly calculated, not only the quadratic term but also a higher-order term can appear. Therefore, as explained below, the calculating unit 13 “evaluates” the range of values that V([Ai]|[Bi]) (i=1, . . . , I) can take. First, the values that the conditional probability represented by p(Ai|Bi) can take, that is, the values that V([Ai]|[Bi]) can take with respect to i=1, . . . , I are fit in the range of the closed section [0, 1] on the real number line. This is proved from the conditional probability definition formulas.

Since a dependency relation can be present among a plurality of pieces of V([Ai]|[Bi]), values that (V([A1]|[B1]), . . . , V([AI]|[BI])) can take in I direct products of [0, 1] are considered. First, the calculating unit 13 divides the I direct products of [0, 1] into N^{I} hypercubes (hereinafter referred to as “grids”) having width 1/N (respectively including boundaries). The calculating unit 13 (the truth value determining unit 131) determines, about obtained respective hypercubes H having the width 1/N, whether the entire H are included in the range of values that (V([A1]|[B1]), . . . , V([AI]|[BI])) can take and whether a part or the entire H are included in the range of values that (V([A1]|[B1]), . . . , V([AI]|[BI])) can take. That is, when the entire H are included in the range of values that (V([A1]|[B1]), . . . , V([AI]|[BI])) can take, the truth value determining unit 131 determines that the grids H correspond to “inside”. When not the entire H but only a part of the H are included in the range of values that (V([A1]|[B1]), . . . , V([AI]|[BI])) can take, the truth value determining unit 131 determines that the grids H correspond to “boundary”. When none of H are included in the range of values that (V([A1]|[B1]), . . . , V([AI]|[BI])) can take, the truth value determining unit 131 determines that the grids H correspond to “outside”.

The truth value determining unit 131 can evaluate the range of values that (V([A1]|[B1]), . . . , V([AI]|[BI])) can take, from the “inner side” in the sense that the range of values that (V([A1]|[B1]), . . . , V([AI]|[BI])) can take includes the union of all internal grids. On the other hand, the truth value determining unit 131 can evaluate the range of values that (V([A1]|[B1]), . . . , V([AI]|[BI])) can take, from the “outer side” in the sense that the union of all internal grids and all boundary grids includes the range of values that (V([A1]|[B1]), . . . , V([AI]|[BI])) can take. The truth value determining unit 131 determines the truth value of a real number closed formula. In other words, the truth value determining unit 131 determines the truth value in the real closed fields. As explained below, the real number closed formula concerns the range of values that the real number variables can take at the time when the real number first-order formulas are constraint conditions.

The output device 15 outputs a determination result to be perceptible for the user. This is explained in detail below.

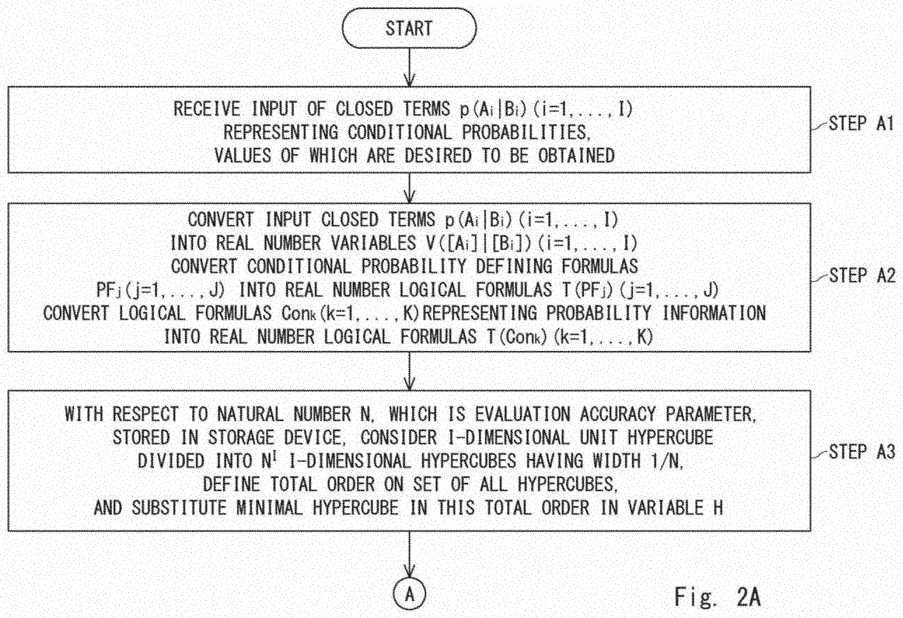

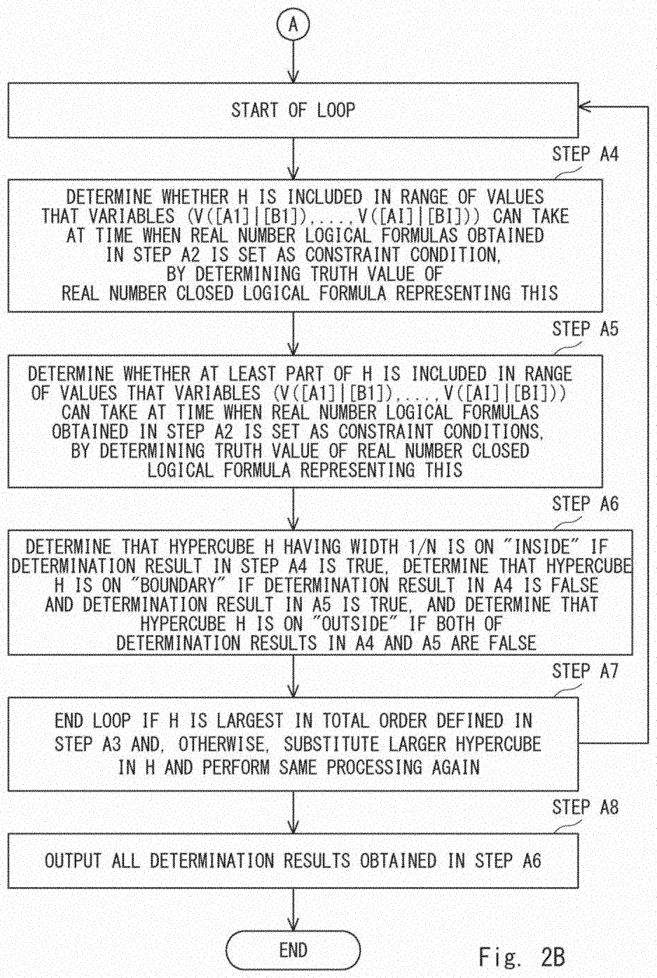

Details of an operation in the first example embodiment are explained below with reference to FIG. 2.

### (Explanation of an Operation)

FIG. 2A and FIG. 2B are flowcharts showing the operation of the information processing system 100 according to the first example embodiment. Note that, in the following explanation, FIG. 2A and FIG. 2B are sometimes collectively simply referred to as FIG. 2. First, the input device 11 receives closed terms p(Ai|Bi) (i=1, . . . , I) representing conditional probabilities, values of which are desired to be obtained (step A1).

Subsequently, the converting unit 12 applies conversion T explained below to perform conversion (step A2). Specifically, the converting unit 12 applies the conversion T to convert the input closed terms p(Ai|Bi) (i=1, . . . , I) into real number variables T(p(Ai|Bi))=V([Ai]|[Bi]) (i=1, . . . , I). The converting unit 12 applies the conversion T to convert a conditional-probability-defining formulas PFj (j=1, . . . , J) into real number first-order formulas T(PFj) (j=1, . . . , J). The converting unit 12 applies the conversion T to convert logical formulas Conk (k=1, . . . , K) representing probability information into real number first-order formulas T(Conk) (k=1, . . . , K).

The conversion T used in the converting unit 12 is composite mapping for applying three mappings T1, T2, and T3 explained below in this order. The respective mappings T1, T2, and T3 are defined as follows using mathematical induction on the configuration of a logical formula.

T1 is conversion for replacing a propositional formula A with the corresponding element [A] of the Lindenbaum-Tarski algebra L. L is the Lindenbaum-Tarski algebra configured from the set of all propositional variables stored in the storage device 14. Note that the other variable symbols, function symbols, predicate symbols, logical connectives, or quantifiers are converted in the homomorphic manner. Therefore, for example, p(A|B) is converted into p([A]|[B]) by T1. A more complicated logical formula (∀ x:form)(p(x|A)+p(¬x|A)=1) is converted into (∀ x:form)(p(x|[A])+p(¬x|[A])=1) by T1.

T2 is conversion for, so to speak, “embodying” a present quantifier of sort form as indicated by the following Expression 2.

$$\begin{matrix}[ Math . 2 ] & \\ {T}_{2} ( ( ∃ x : form ) ϕ ) = {∨}_{z ∈ L} {T}_{2} ( ϕ ) [ z / x ] & ( 2 )\end{matrix}$$

Note that the other variable symbols, function symbols, predicate symbols, logical connectives, or quantifiers are converted in the homomorphic manner. T2(φ)[z/x] means the result obtained by substituting z in all occurrence of x in a logical formula T2(φ). When a part where an arithmetic operation of the Lindenbaum-Tarski algebra L can be performed appears anew through substitution operation, the arithmetic operation is performed. Note that, since the number of propositional variables are finite as explained above, the number of elements of the Lindenbaum-Tarski algebra L is also finite. Therefore, it is guaranteed that the right side of Expression 2 is a disjunction of the finite number of logical formulas.

Note that, as an example of the conversion, p([A]|[B]) is converted as T2(p([A]|[B]))=p(T2([A])|T2([B]))=p([A]|[B]). As a result, the same thing is output. (∀ x:form)(p(x|[A])+p(¬x|[A])=1) is converted as follows because (∀ x:form)φ is an abbreviation of ¬(∃ x:form)¬φ.

$$\begin{matrix}[ Math . 3 ] & \\ {T}_{2} ( ( ∀ x : form ) p ( x \vert [ A ] ) + p ( ¬ \vert [ A ] ) = 1 ) = {T}_{2} ( ¬ ( ∃ x : form ) ¬ ( p ( x \vert [ A ] ) + p ( ¬ x \vert [ A ] ) = 1 ) ) = ¬ {T}_{2} ( ( ∃ x : form ) ¬ ( p ( x \vert [ A ] ) + p ( ¬ x \vert [ A ] ) = 1 ) ) = {∨}_{z ∈ L} {T}_{2} ( ¬ ( p ( z \vert [ A ] ) + p ( ¬ z \vert [ A ] ) = 1 ) ) = ¬ {∨}_{z ∈ L} ¬ {T}_{2} ( p ( z \vert [ A ] ) + p ( ¬ z \vert [ A ] ) = 1 ) ) = ¬ {∨}_{z ∈ L} ¬ ( {T}_{2} ( p ( z \vert [ A ] ) + p ( ¬ z \vert [ A ] ) ) = {T}_{2} ( 1 ) ) = ¬ {∨}_{z ∈ L} ¬ ( {T}_{2} ( p ( z \vert [ A ] ) ) + {T}_{2} ( p ( ¬ z \vert [ A ] ) ) = {T}_{2} ( 1 ) ) = ¬ {∨}_{z ∈ L} ¬ ( p ( z \vert [ A ] ) + p ( ¬ z \vert [ A ] ) = 1 ) & ( 3 )\end{matrix}$$

T3 converts p([A]|[B]) into V([A]|[B]). T3 converts other cases in the homomorphic manner. For example, when the above Expression 3 is converted by T3, the conversion of T3 performs as indicated by the following Expression 4.

$$\begin{matrix}[ Math . 4 ] & \\ {T}_{3} ( ¬ {∨}_{z ∈ L} ¬ ( p ( z \vert [ A ] ) + p ( ¬ z \vert [ A ] ) = 1 ) ) = ¬ {∨}_{z ∈ L} ¬ ( V ( z \vert [ A ] ) + V ( z \vert [ A ] ) + V ( ¬ z \vert [ A ] ) = 1 ) & ( 4 )\end{matrix}$$

Closed term representing input conditional probabilities are described as p(Ai|Bi) (i=1, . . . , I). The conditional-probability-defining formulas stored in the storage device 14 are described as PFj (j=1, . . . , J). The logical formulas representing probability information also stored in the storage device 14 is described as Conk(k=1, . . . , K). The converting unit 12 converts p(Ai|Bi) (i=1, . . . , I) into T(p(Ai|Bi))(=V([Ai]|[Bi])) (i=1, . . . , I) using the composite mapping T for applying T1, T2, and T3 described above in this order. The converting unit 12 converts PFj (j=1, . . . , J) into T(PFj) (j=1, . . . , J) using the composite mapping T for applying T1, T2, and T3 in this order. Further, the converting unit 12 converts Conk(k=1, . . . , K) into T(Conk) (k=1, . . . , K) using the composite mapping T for applying T1, T2, and T3 in this order.

Subsequently, under T(PFj) (j=1, . . . , J) and T(Conk) (k=1, . . . , K) set as constraint conditions, the calculating unit 13 calculates a range of values that a set (V([A1]|[B1]), . . . , V([AI]|[BI]) can take (steps A3 to A7). First, in step A3, with respect to a natural number N, which is a parameter of evaluation accuracy, stored in the storage device 14, the calculating unit 13 considers an I-dimensional unit hypercube divided into N^{I} I-dimensional hypercubes having width 1/N and defines a total order on all the hypercubes. The calculating unit 13 substitutes the minimum hypercube in a variable H in the total order.

Specifically, first, the calculating unit 13 divides an I-dimension unit hypercube [0, 1]× . . . ×[0, 1] into N^{I} hypercubes [0, 1/N]× . . . ×[0, 1/N], . . . , [(M1)−1)/N, M1/N]× . . . ×[((Mi)−1)/N, Mi/N]× . . . ×[((MI)−1)/N, MI/N], . . . , [(N−1)/N, 1]× . . . ×[(N−1)/N, 1] (Mi=1, . . . , N, i=1, . . . , I). The hypercubes [((M1)−1)/N, M1/N]× . . . ×[((MI)−1)/N, MI/N] are referred to as grids. Subsequently, the calculating unit 13 selects the grids [((M1)−1)/N, M1/N]× . . . ×[((MI)−1)/N, MI/N] in order. In order to repeatedly perform processing (steps A4 to A6) explained below, the calculating unit 13 prepares the variable H in which a selected grid is substituted and substitutes [0, 1/N]× . . . ×[0, 1/N], which is the first grid, in the variable H. That is, the variable H is a parameter indicating a grid. Note that selecting order is optional and the first (minimum) grid does not need to be [0, 1/N]× . . . ×[0, 1/N].

Repetition steps (steps A4 to A6) are explained below. First, the truth value determining unit 131 determines to which of an inside, an outside, and a boundary the grid H corresponds. To this end, the truth value determining unit 131 determines the truth values of two propositions. Note that, in the following explanation, a notation a≤b≤c is an abbreviated notation of a≤bΛb≤c.

The truth value determining unit 131 performs first determination (step A4). That is, the truth value determining unit 131 determines whether all H are included in a range of values that a variable set (V([A1]|[B1]), . . . , V([AI]|[BI])) can take at the time when a real number logical formula group obtained in step A2 is set as a constraint condition, by determining the truth value of a real number closed logical formula representing this. In other words, the truth value determining unit 131 determines whether H=[((M1)−1)/N, M1/N]× . . . ×[((MI)−1)/N, MI/N] is included in a range of values that the variable set (V([A1]|[B1]), . . . , V([AI]|[BI])) can take when real number logical formula groups T(PFj) (j=1, . . . , J) and T(Conk) (k=1, . . . , K) obtained in step A2 are set as constraint conditions, by determining truth value of a real number closed logical formula representing this.

Specifically, the truth value determining unit 131 determines the truth value of a real number closed logical formula indicated by the following Expression 5.

$$\begin{matrix}[ Math . 5 ] & \\ ( ∀ V ( [ A ] \vert [ B ] ) ) … ( ∀ V ( [ {A}_{I} ] \vert [ {B}_{I} ] ) ) [ {∧}_{i = 1 … I} ( \frac{{M}_{i} - 1}{N} \leq V ( [ {A}_{i} ] \vert [ {B}_{i} ] ) \leq \frac{{M}_{i}}{N} ) & ( 5 )\end{matrix}$$

$$\to ( other than a group ( ∃ V ( [ Ai ] \vert [ Bi ] ) ) ) ( {∧}_{j = 1 … J} T ( {PF}_{j} ) {∧}_{k = 1 … K} T ( {Con}_{k} ) ) \vert$$

“Other than a group ((∃ V[Ai]|[Bi])))” of the above Expression 5 is obtained by arranging “(∃ V(x|y))” for all pair (x, y) of all elements of the Lindenbaum-Tarski algebra excluding ([Ai], [Bi]) (i=1, . . . , I). A proposition represented by this logical formula is “if a variable set (V([A1]|[B1]), . . . , V([AI]|[BI])) takes a value included in H=[((M1)−1)/N, M1/N]× . . . ×[((MI)−1)/N, MI/N], all of T(PFj) (j=1, . . . , J) and T(Conk) (k=1, . . . , K) can be satisfied by appropriately taking values allocated to other variable groups V(x|y)”.

The truth value determining unit 131 performs second determination (step A5). That is, the truth value determining unit 131 determines whether at least a part or all of H are included in a range of values that a variable set (V([A1]|[B1]), . . . , V([AI]|[BI])) can take at the time when the real number logical formula group obtained in step A2 is set as a constraint condition, by determining the truth value of a real number closed logical formula representing this. In other words, the truth value determining unit 131 determines whether at least a part of H are included in a range of values that the variable set ((V([A1]|[B1]), . . . , V([AI]|[BI])) can take when the real number logical formula groups T(PFj) (j=1, . . . , J) and T(Conk) (k=1, . . . , K) obtained in step A2 are set as constraint conditions, by determining the truth value of a real number closed logical formula representing this.

Specifically, the truth value determining unit 131 determines the truth value of a real number closed logical formula indicated by the following Expression 6.

$$\begin{matrix}[ Math . 6 ] & \\ ( ∃ V ( [ {A}_{1} ] \vert [ {B}_{1} ] ) ) … ( ∃ V ( [ {A}_{I} ] [ \vert [ {B}_{I} ] ) ) [ {∧}_{i = 1 … I} ( \frac{{M}_{i} - 1}{N} \leq V ) ( [ {A}_{i} ] \vert [ {B}_{i} ] ) \leq \frac{{M}_{i}}{N} ) & ( 6 )\end{matrix}$$

$$Λ ( other than a group ( ∃ V ( [ Ai ] [ Bi ] ) ) ) ( {∧}_{j = 1 … J} T ( {PF}_{j} ) {∧}_{k = 1 … K} T ( {Con}_{k} ) ) ]$$

A proposition represented by this logical formula is “all of T(PFj) (j=1, . . . , J) and T(Conk) (k=1, . . . , K) can be satisfied by appropriately taking values allocated to the variable set (V([A1]|[B1]), . . . , V([AI]|[BI])) from H=[(M1−1)]/N, M1/N]× . . . ×[(MI−1)/N, MI/N] and further appropriately taking values allocated to other variables”.

The calculating unit 13 determines, using determination results of the truth values of Expression 5 and Expression 6 explained above, which of the inside, the outside, and the boundary the grid H corresponds (step A6). That is, the calculating unit 13 determines that the hypercube having the width 1/N is on the “inside” if the determination result in step A4 is true, determines that the hypercube is on the “boundary” if the determination result in A4 is false and the determination result in A5 is true, and determines that the hypercube is on the “outside” if both of the determination results in A4 and A5 are false. In other words, if Expression 5 is true, the calculating unit 13 determines that the grid H=[(M1−1)/N, M1/N]× . . . ×[(MI−1)/N, MI/N] corresponds to the “inside”. If Expression 5 is false and Expression 6 is true, the calculating unit 13 determines that the grid H=[(M1−1)/N, M1/N]× . . . ×[(MI−1)/N, MI/N] corresponds to the “boundary”. If both of Expression 5 and Expression 6 are false, the calculating unit 13 determines that the grid H=[(M1−1)/N, M1/N]× . . . ×[(MI−1)/N, MI/N] corresponds to the “outside”.

Thereafter, the calculating unit 13 determines whether to end a loop (step A7). Specifically, the calculating unit 13 ends the loop if H is the largest (that is, the last grid) in the total order defined in step A3. On the other hand, otherwise, the calculating unit 13 substitutes a larger (that is, the next) grid (hypercube) in the total order in H and performs the same processing (A4 to A6) again.

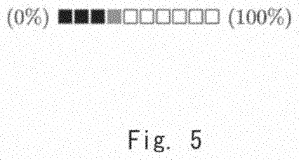

The output device 15 outputs all the determination results obtained in step A6 (step A8). That is, the output device 15 outputs a determination result concerning to which of the “inside”, the “boundary”, and the “outside” the grids correspond. Note that, in the case of I=1, 2, and 3, dimensions of a unit hypercube and a grid group included in the unit hypercube are respectively one dimension, two dimensions, and three dimensions. Therefore, it is possible to graphically display the grids such that a positional relation is kept. At this time, the grids on the “inside”, the “boundary”, and the “outside” may be respectively colored in “black”, “gray”, “white”, and the like (see FIG. 5 referred to below).

### (Explanation of Effects)

Subsequently, effects of the first example embodiment are explained. The conditional probability calculation device 1 according to the first example embodiment includes the converting unit 12. Consequently, it is possible to convert a closed term representing a conditional probability into a real number variable and further convert a conditional probability definition formula and a logical formula representing probability information into equivalent real number logical formulas. Therefore, the problem of calculating a conditional probability can be resulted in a problem of calculating a range of values that a real number variable group can take at the time when a real number logical formula group is set as a constraint condition. As a result, it is possible to calculate a conditional probability based on probability information. By using the calculating unit 13, it is possible to determine whether the conditional probability can take values at all points in a designated range (grid) (step A4) and whether the conditional probability can take a value at a certain point in the designated range (grid) (step A5). Consequently, it is possible to evaluate, from the inner side and the outer side, a range of values that the conditional probability can take.

In the first example embodiment, it is not a question whether the probability information is complete. Therefore, even when the probability information is incomplete, there is an effect that it is possible to calculate, based on given probability information, a range of values that a designated conditional probability can take.

Further, since the conditional probability logical formula is used as the description form of the probability information, information represented using an inequality and an equality between higher-order polynomials that can be expressed by the conditional probability logical formula, Boolean connectives such as A and ¬, and quantifiers can be used as the probability information. The conditional probability definition formula group and the logical formula group representing probability information according to this example embodiment are allowed to have content expressed using the Boolean connectives and the quantifiers with respect to the inequality and the equality between the higher-order polynomials that can be expressed by conditional probability logical formulas. That is, the conditional probability definition formula group and the logical formula group representing probability information according to this example embodiment are allowed to have a logical formula using the Boolean connectives and the quantifiers with respect to the inequality and the equality between the higher-order polynomials that can be expressed by conditional probability logical formulas. Consequently, for example, independency p(AΛB|True)=p(A|True)p(B|True), conditional independency p(AΛB|C)=p(A|C)p(B|C), and conditional independency (∀ z:form)[p(AΛB|z)=p(A|z)p(B|z)] for any condition, and the like can be considered as probabilistic information. This is one of remarkable effects of this example embodiment compared with the fact that the input in Non Patent Literature 1 is only the upper limit and the lower limit of the occurrence probability of the proposition represented by the specific logical formula.

Further, in the first example embodiment, the conjunction of a propositional formula group C1, . . . , CN representing events known as already realized can be used as the condition section B of a conditional probability P(A|B) to be calculated. Consequently, there is also an effect that it is possible to calculate, by calculating the range of values that P(A|C1Λ . . . ΛCN) can take, the range of values that a probability of occurrence of an event represented by A at this time can take.

Note that, in the first example embodiment, setting of the evaluation accuracy 1/N may be able to be performed from the input device 11 at any time. Different evaluation accuracy 1/Ni may be associated with each i of the closed terms P(Ai|Bi) (i=1, . . . , I) representing the conditional probability input in step A1. Further, a parameter of the evaluation accuracy may be not a natural number Ni and may be a nonnegative real number Ri. In this case, for example, a method of taking the minimum natural number Ni equal to or larger than Ri and setting the width of a grid to 1/Ni may be adopted. Alternatively, a method of basically setting the width of the grid to 1/Ri and allowing the width of a grid at an end to 1/Ri or less may be adopted. The evaluation accuracy parameter may be the evaluation accuracy itself. In this case, the inverse of the evaluation accuracy is taken and the following processing is performed.

It is not essential to store propositional variables. Actually, if all propositional variables that should be considered appear in the conditional probability definition formulas and the logical formulas representing probability information stored in the storage device 14, it is possible to obtain the same effect by adding processing for taking out propositional variables (excluding overlap) in which the propositional variables occur. However, it is also likely that not all of the propositional variables that should be considered appear in the conditional-probability-defining formulas and the logical formulas representing probability information. In this case, by causing the storage device 14 to store these propositional variables, at the time of calculation of conditional probabilities of propositional formulas, in particular, at the time of the conversion by T2 in the converting unit 12, all the propositional variables that should be considered can be considered.

Note that this example embodiment can also be realized as a conditional probability calculation program for a propositional formula for causing a computer to function as a conditional probability calculation system for a propositional formula (the same applies in other example embodiments). The computer includes a central processing unit (CPU), a storage device (a hard disk or the like), an input unit such as a keyboard, and a display unit such as a display. The central processing unit reads and executes the conditional probability calculation program for the propositional formula. The storage device stores a conditional probability definition formula group, a logical formula group representing probability information, a propositional variable group, an evaluation accuracy parameter, and the like. The storage device may store the conditional probability calculation program for propositional formulas. Referring to this example embodiment as an example, the conditional probability calculation program for the propositional formula read by the CPU causes the computer to function as the converting unit and the calculating unit explained in this example embodiment.

### Specific Example

Subsequently, a specific configuration and a specific operation in the first example embodiment are explained with reference to a specific example.

### (Explanation of a Configuration)

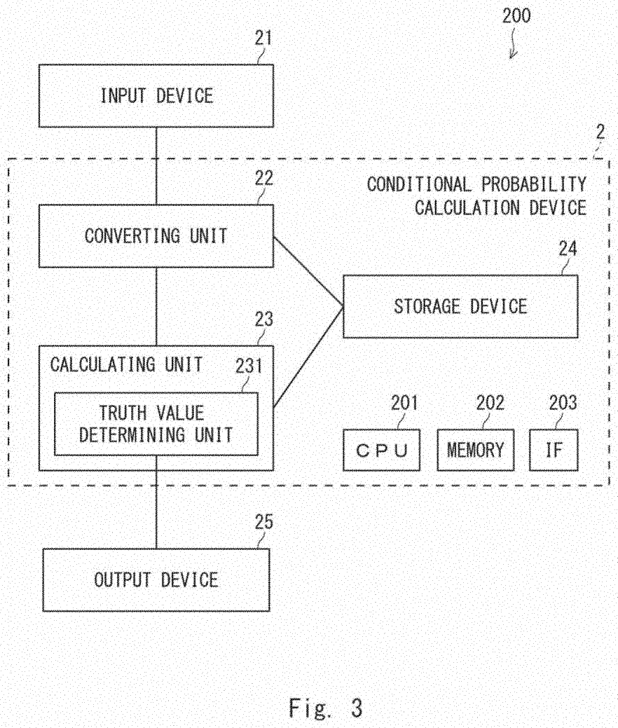

FIG. 3 is a block diagram showing an information processing system 200 according to a specific example of the first example embodiment. As shown in FIG. 3 the information processing system 200 according to the specific example of the first example embodiment includes a conditional probability calculation device 2, an input device 21, and an output device 25.

The conditional probability calculation device 2 has a function of a computer such as a personal computer. The conditional probability calculation device 2 includes a CPU 201 (a processor), a memory 202, a network interface 203 (an IF), and a storage device 24 (a storage) as hardware components. Note that the conditional probability calculation device 2 may include an input device 21 and an output device 25 as hardware components. Note that the hardware components can also be applied to the other example embodiments.

The conditional probability calculation device 2 includes a converting unit 22 and a calculating unit 23. The converting unit 22 is communicably connected to the input device 21 and the storage device 24. The calculating unit 23 is connected to the converting unit 22, the storage device 24, and the output device 25. The calculating unit 23 includes an truth value determining unit 231. The converting unit 22 and the calculating unit 23 can be configured by a computer. The storage device 24 may include a computer-readable reading device or magnetic storage device such as a flexible disk or a CD-ROM (Compact Disc Read Only Memory).

The CPU 201 may develop, on the memory 202, a program code received from the network interface 203. Alternatively, the CPU 201 may read out a program code stored in the storage device 24 (a CD-ROM, a magnetic storage device, or the like) and develop the program code on the memory 202. The CPU 201 interprets and executes the program code developed on the memory 202, whereby various functions can be realized as the converting unit 22 and the calculating unit 23 including the truth value determining unit 231 shown in FIG. 3. Necessary programs may be recorded in any nonvolatile recording medium and installed according to necessity to realize the components (the converting unit 22 and the calculating unit 23). Alternatively, the components are not limited to being realized by software by a program and may be realized by, for example, a combination of any of hardware, firmware, and software. The components may be realized using an integrated circuit programmable by the user such as an FPGA (field-programmable gate array) or a microcomputer. In this case, the program configured from the components may be realized using the integrated circuit.

In this example, the truth value determining unit 231 can be realized by an rlqe command of Redlog, which is a QE tool of Reduce. The rlqe command realizes an algorithm of quantifier elimination (QE) of a real number first-order predicate logic. The rlqe command returns, to a closed logical formula not including a free variable, the truth value of the closed logical formula.

The storage device 24 includes at least a network interface and a magnetic storage device. The storage device 24 stores a conditional probability definition formula group (i.e., conditional probability definition formulas), a logical formula group (i.e., logical formulas) representing probability information, a propositional variable group (i.e., propositional variables), and a parameter of evaluation accuracy. In this example, it is assumed that the following logical formulas PF1 to PF6 are stored as the conditional probability definition formula group (see p. 337 of Non Patent Literature 3). Note that a logical formula group other than the following PF1 to PF6 can also be applied, as long as it is a conditional probability logical formula group representing a conditional probability definition.

PF1: (∀ x:form)(∀ y:form)(∃ x′:form)(∃ y′:form)p(x|y)≠p(x′|y′)
PF2: (∀ x:form)(∀ y:form)[((∀ z:form)p(x|z)=p(y|z))→((∀ w:form)p(w|x)=p(w|y))]
PF3: (∀ x:form)(∀ y:form)p(x|x)=p(y|y)
PF4: (∀ x:form)(∀ y:form) (V z:form)p(xΛy|z)≤p(x|z)
PF5: (∀ x:form)(∀ y:form) (V z:form)p(xΛy|z)=p(x|yΛz)p(y|z)
PF6: (∀ x:form)(∀ y:form)[(¬(V z:form)p(y|y)=p(z|y))→p(x|y)+p(¬x|y)=p(y|y)]

PF1 to PF3 are logical formulas indicating characteristics unrelated to both of Λ and ¬. PF4 and PF5 are logical formulas indicating characteristics concerning A. PF6 is a logical formula indicating a characteristic concerning ¬. PF1 indicates that an obvious (for example, taking a value 1 in any argument) probability taking the same value in all arguments is absent. PF2 indicates that, if values of probabilities p(x|z) and p(y|z) of x and y under any condition z are the same, x and y can be identified from a probabilistic viewpoint and conditioning by x and conditioning by y are equivalent, that is, conditional probabilities p(w|x) and p(w|y) are the same value with respect to any w. PF3 indicates that p(x|x)=1 is finally proved from these six principles. Note that 1 is not written from the beginning because the writer Popper of Non Patent Literature 3 describes these six principles as not depending on a real number in order to prove that a probability value being a real number is independent from the six principles (=definitions) (see p. 347 of Non Patent Literature 3).

PF4 indicates that a probability of xΛy is smaller than a probability of x with the condition z. PF5 indicates a relation between a conditional probability and an unconditional probability. Actually, if the condition z is neglected, p(xΛy)=p(x|y)p(y). This is obtained by removing the denominator p(y) from a general conditional probability definition p(x|y)=p(xΛy)/p(y). PF6 indicates that, when not “p(z|y)=1 in all z” (since y can be regarded as False (p(z|y)=1 in all y, this means that y is not False), a sum of a probability of x and a probability of ¬x is 1 under the condition y.

It is assumed that p(stomach cancer|colon cancer)=½ and p(lung cancer|colon cancer)=⅓ are stored as the logical formula group representing probability information. It is assumed that “stomach cancer”, “lung cancer”, and “colon cancer” are stored as the propositional variable group. Further, it is assumed that a natural number “10” is stored as the parameter of the evaluation accuracy.

### (Explanation of an Operation)

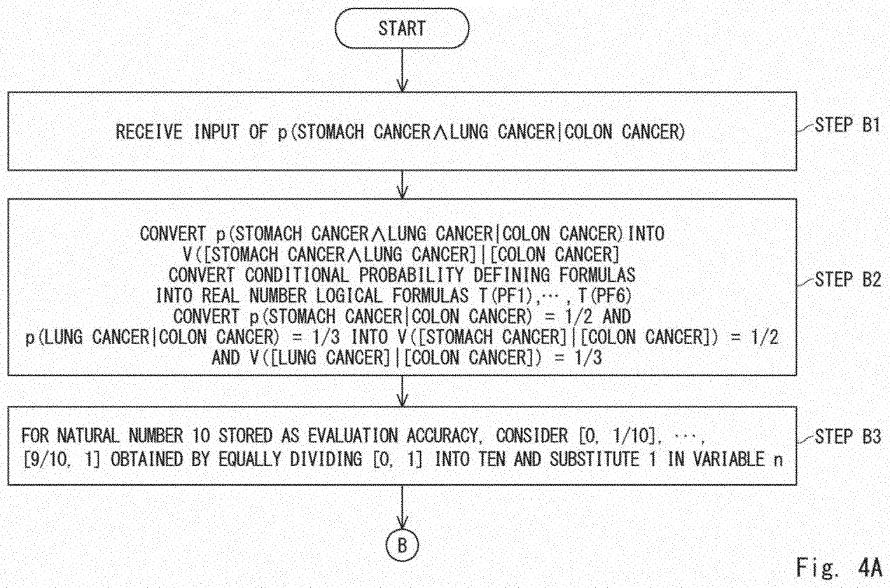

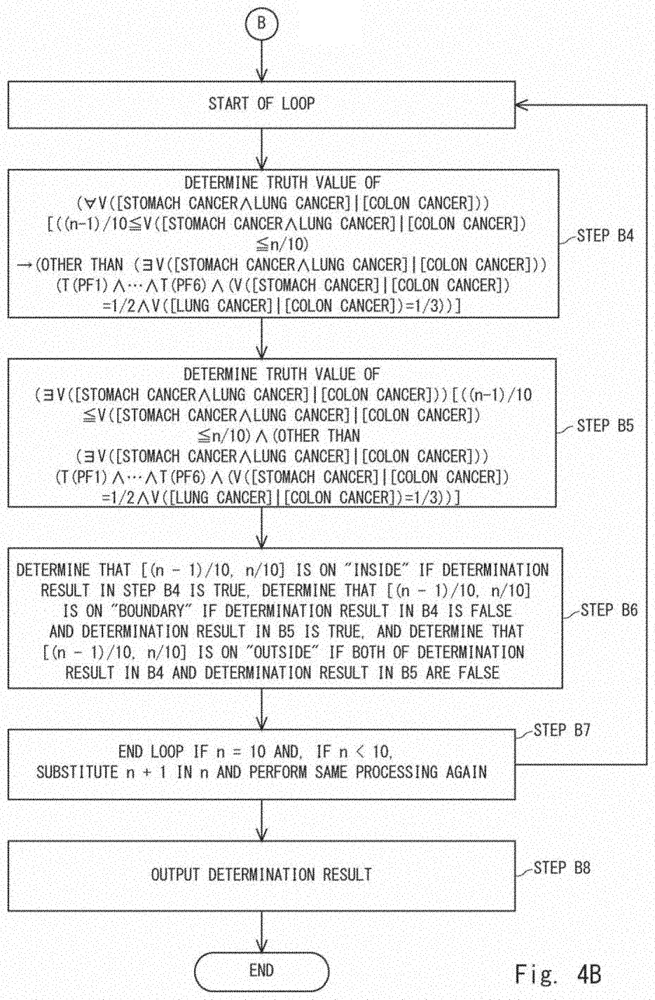

FIG. 4A and FIG. 4B are flowcharts showing the operation of the information processing system 200 according to the specific example of the first example embodiment. Note that, in the following explanation, FIG. 4A and FIG. 4B are sometimes collectively simply referred to as FIG. 4. First, the input device 21 receives a closed term p (stomach cancerΛlung cancer|colon cancer) representing a conditional probability desired to be calculated (step BI).

Subsequently, the converting unit 22 applies the conversion T explained above to perform conversion as explained below (step B2). Specifically, the converting unit 22 converts the closed term p(stomach cancerΛlung cancer|colon cancer) representing the input conditional probability into a real number variable V([stomach cancerΛlung cancer]|[colon cancer]). The converting unit 22 converts the conditional probability definition formula group PF1, . . . , PF6 stored in the storage device 24 into real number first-order formulas T(PF1), . . . , T(PF6). The converting unit 22 converts p(stomach cancer|colon cancer)=½ and p(lung cancer|colon cancer)=⅓ respectively into V([stomach cancer]|[colon cancer])=½ and V([lung cancer]|[colon cancer])=⅓.

An element of the Lindenbaum-Tarski algebra is described as follows using the propositional variable group “stomach cancer”, “lung cancer”, and “colon cancer” stored in the storage device 24. As allocations of truth values to the propositional variables “stomach cancer”, “lung cancer”, and “colon cancer”, there are eight ways of (stomach cancer: true, lung cancer: true, colon cancer: true), . . . , (stomach cancer: false, lung cancer: false, colon cancer: false). About these allocations, the conjunctions, in which the propositional variable remains if it is true and the propositional variable is negated if it is false, that is, (stomach cancerΛlung cancerΛcolon cancer), . . . , (¬stomach cancerΛ¬lung cancerΛ¬colon cancer), are taken.

For any logical formula X, [X] is associated with disjunctions of conjunctions of allocations in which X is true. For example, “stomach cancerΛlung cancer” is true in (stomach cancer: true, lung cancer: true, colon cancer: true) and (stomach cancer: true, lung cancer: true, colon cancer: false). Therefore, [stomach cancerΛlung cancer] is described as (stomach cancerΛlung cancerΛcolon cancer)∨(stomach cancerΛlung cancerΛ¬colon cancer). Similarly, [colon cancer] is described as (stomach cancerΛlung cancerΛcolon cancer)∧(stomach cancerΛ¬lung cancerΛcolon cancer)∧(¬stomach cancerΛlung cancerΛcolon cancer)∧(¬stomach cancer∧¬lung cancerΛcolon cancer).

The converting unit 22 convers p(stomach cancerΛlung cancer|colon cancer) into a real value variable V ([stomach cancerΛlung cancer]|[colon cancer]) using this notation. Further, the converting unit 22 converts the conditional-probability-defining formulas and the logical formulas representing probability information as follows. That is, the converting unit 22 converts p(stomach cancer|colon cancer)=½ into V([stomach cancer]|[colon cancer])=½ and converts p(lung cancer|colon cancer)=⅓ into V([lung cancer]|[colon cancer])=⅓. Note that, concerning the logical formula PF1, . . . , and PF6, refer to “explanation of an operation” in the “first example embodiment”. PF3 is converted into Expression 1.

Subsequently, for natural number 10 stored as an evaluation accuracy parameter, the calculating unit 23 equally divides [0, 1] into ten of [0, 1/10], . . . , and [ 9/10, 1] and substitutes 1 in a variable n (step B3). Note that this n is a parameter representing a grid [(n−1)/10, n/10].

The calculating unit 23 performs loop processing explained below for this variable n (steps B4 to B6). First, the truth value determining unit 231 determines truth value of the following Expression 7 (step B4).

$$\begin{matrix}[ Math . 7 ] & \\ ( ∀ V [ stomach cancer Λ lung cancer ] [ colon cancer ] ) ) & ( 7 )\end{matrix}$$

$$[ ( n - 1 ) / 10 \leq V ( [ stomach cancer Λ lung cancer ] [ colon cancer ] ) \leq n / 10 )$$

$$\to ( other than a group ( ∃ V [ stomach cancer Λ lung cancer ] [ colon cancer ] ) )$$

$$( ( {∧}_{j = 1 … J} T ( {PF}_{j} ) ) \hat{} ( V [ stomach cancer ] [ colon cancer ] ) = 1 / 2 ) Λ ( V ( [ lung cancer ] [ colon cancer ] ) = 1 / 3 ) ) ]$$

Subsequently, the truth value determining unit 231 determines the truth value of the following Expression 8 (step B5).

$$\begin{matrix}[ Math . 8 ] & \\ ( ∃ V ( [ stomach cancer Λ lung cancer ] \vert [ colon cancer ] ) ) & ( 8 )\end{matrix}$$

$$[ ( n - 1 ) / 10 \leq V ( [ stomach cancer Λ lung cancer ] \vert [ colon cancer ] ) \leq n / 10 )$$

$$Λ ( other than a group ( ∃ V ( [ stomach cancer Λ lung cancer ] \vert [ colon cancer ] ) = 1 / 3 ) ) ]$$

Note that an algorithm of QE explained above can be used for the determination of the truth value of Expression 7 and Expression 8 described above.

For a closed section [(n−1)/10, n/10], the calculating unit 23 determines that the closed section is on the “inside” if Expression 7 is true, determines that the closed section is on the “boundary” if Expression 7 is false and Expression 8 is true, and determines that the closed section is on the “outside” if both of Expression 7 and Expression 8 are false (step B6). The calculating unit 23 ends a loop if n=10 and, if n<10, substitutes n+1 in n and performs the same processing (B4 to B6) again (step B7).

The output device 25 outputs all determination results obtained in step B6 (step B8). That is, the output device 25 outputs a determination result concerning to which of the “inside”, the “boundary”, and the “outside” the closed sections correspond.

FIG. 5 is a diagram illustrating the determination result (step B8) displayed by the output device 25 according to the specific example of the first example embodiment. For [(n−1)/10, n/10] (n=1, . . . , 10), the output device 25 outputs black if the closed sections are on the “inside”, outputs gray if the closed sections are on the “boundary”, and outputs white if the closed sections are on the “outside” while keeping the positional relation. Squares in FIG. 5 correspond to grids (closed sections). About grids (closed sections) [0, 1/10], [ 1/10, 2/10], and [ 2/10, 3/10], since the grids are determined as being on the “inside”, the grids are displayed in black. About [ 3/10, 4/10], since the grid is determined as being on the “boundary”, the grid is displayed in gray. About [ 4/10, 5/10], [ 5/10, 6/10], [ 6/10, 7/10], [ 7/10, 8/10], [ 8/10, 9/10], and [ 9/10, 10/10], since the grids are determined as being on the “outside”, the grids are displayed in white. Note that, actually, a range of values that P(lung cancerΛstomach cancer|colon cancer) can take is 0≤P(lung cancerΛstomach cancer|colon cancer)≤⅓, that is, 0%≤P(lung cancerΛstomach cancer|colon cancer)≤33.33%.

### (Explanation of Effects)

According to the above, from probability information P(stomach cancer|colon cancer)=½ and P(lung cancer|colon cancer)=⅓, it is seen that the range of values that the probability of “lung cancer and stomach cancer” can take when it is known that colon cancer is got is 0% or more and 30% or less from the inner side (the entire inside grid) and is 0% or more and 40% or less from the outer side (the entire inside and boundary grids). Further, this evaluation can be optionally increased in accuracy by increasing evaluation accuracy from 10 in this example to 100, 1000, or the like. For example, if the evaluation accuracy is 100, it is seen that, for the range of values that the probability of “stomach cancer and lung cancer” can take, an evaluation from the inner side is 0% or more and 33% or less and an evaluation from the outer side is 0% or more and 34% or less.

### Second Example Embodiment

(Explanation of a configuration)

Subsequently, the second example embodiment of the present disclosure is explained with reference to the drawings.

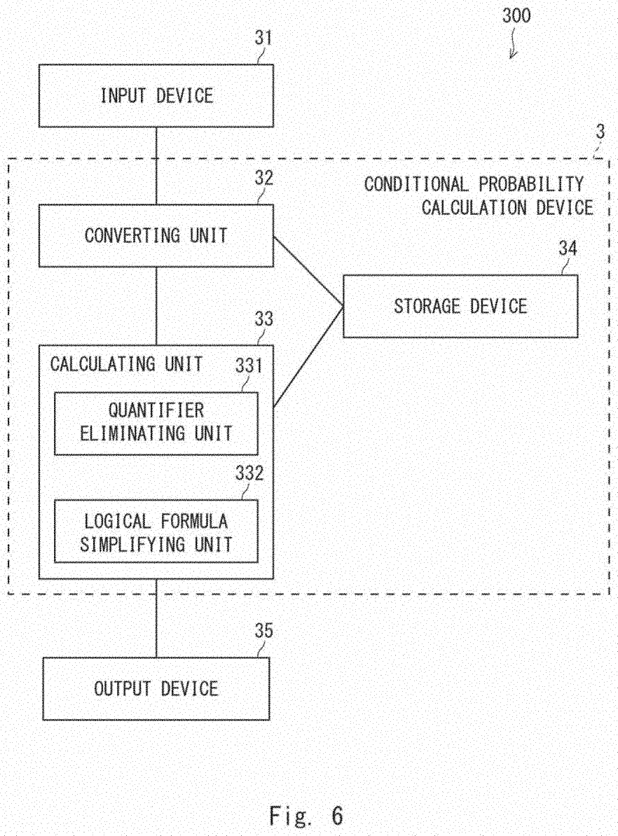

FIG. 6 is a block diagram showing an information processing system 300 according to the second example embodiment. As shown in FIG. 6, the information processing system 300 according to the second example embodiment includes a conditional probability calculation device 3, an input device 31, and an output device 35. The conditional probability calculation device 3 according to the second example embodiment includes a converting unit 32, a calculating unit 33, and a storage device 34. The converting unit 32 is connected to the input device 31, the calculating unit 33, and the storage device 34. The calculating unit 33 is connected to the converting unit 32, the storage device 34, and the output device 35. The calculating unit 33 includes a quantifier eliminating unit 331 and a logical formula simplifying unit 332. Referring to FIG. 6, the calculating unit 33 according to the second example embodiment is different from the calculating unit 13 according to the first example embodiment. The calculating unit 33 includes the quantifier eliminating unit 331 and the logical formula simplifying unit 332 and does not include the truth value determining unit 131. The other components in the second example embodiment are substantially the same as the components according to the first example embodiment.

The components of the conditional probability calculation device 3 respectively schematically operate as explained below. First, the input device 31 and the converting unit 32 are the same as the input device 11 and the converting unit 12 and perform the same operations as the operations of the input device 11 and the converting unit 12. That is, the operations of the components other than the calculating unit 33 are substantially the same as the operations of the components according to the second example embodiment.

A real number logical formula configured by the calculating unit 33 first is the following Expression 9.

$$\begin{matrix}[ Math . 9 ] & \\ ( other than a group ( ∃ V ( [ Ai ] \vert [ Bi ] ) ) ) ( {∧}_{j = 1 … J} T ( {PF}_{j} ) {∧}_{k = 1 … K} T ( {Con}_{k} ) ) & ( 9 )\end{matrix}$$

This Expression 9 defines the range of values that real number variables can take, with the real number logical formulas obtained by converting the conditional-probability-defining formulas and logical formulas representing probability information, as a constraint condition. Note that Expression 9 can give the accurate region of the conditional probabilities represented by closed terms input to the input device 31 but is hard to understand for human and poor in readability.

The quantifier eliminating unit 331 converts this Expression 9 into an equivalent real number logical formula including no quantifier. The logical formula simplifying unit 332 simplifies this real number logical formula. As a result, the real number logical formula output by the calculating unit 33 determines the range of values that a variable group (V([A1]|[B1]), . . . , V([AI]|[BI])) can take under the constraints of conditions T(PFj) (j=1, . . . , J) and T(Conk) (k=1, . . . , K). Further, this range is the range of values that a conditional probability (P(A1|B1), . . . , P(AI|BI)) can bake under the constraint represented by a logical formula Conk k=1, . . . , k).

### (Explanation of an Operation)

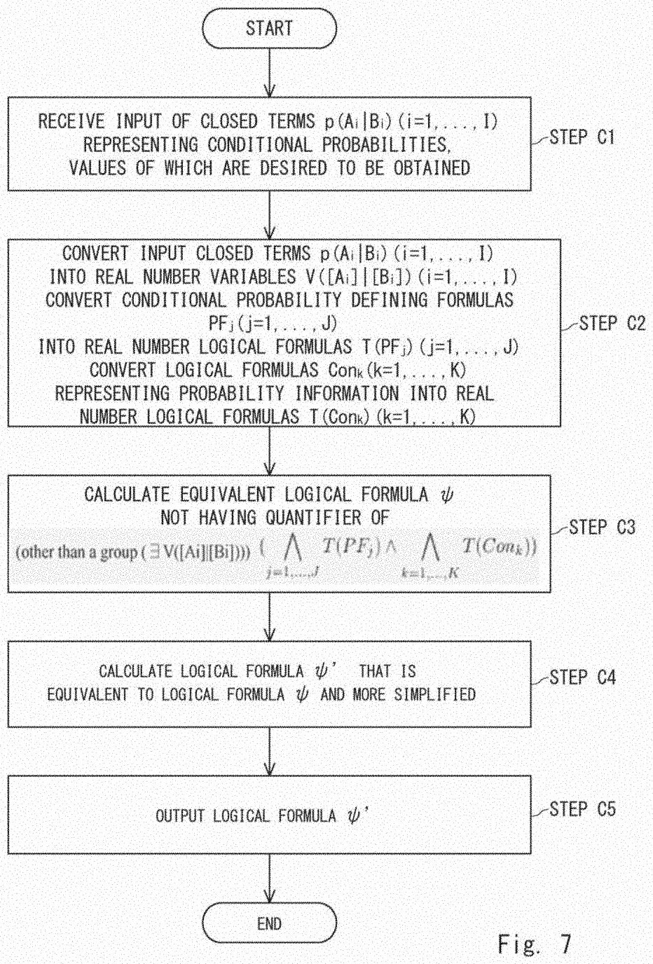

FIG. 7 is a flowchart showing the operation of the information processing system 300 according to the second example embodiment. First, the input device 31 and the converting unit 32 are respectively substantially the same as the input device 11 and the converting unit 12 in the first example embodiment shown in FIG. 1. Therefore, the input device 31 and the converting unit 32 respectively perform substantially the same processing as steps A1 and A2 (steps C1 and C2).

Subsequently, the calculating unit 33 calculates an equivalent real number logical formula yr not including the quantifier of Expression 9 (step C3). Specifically, the quantifier eliminating unit 331 of the calculating unit 33 configures Expression 9 using the real number variables V([Ai]|[Bi]) (i=1, . . . , I) output by the converting unit 32, the real number logical formulas T(PFj) (j=1, . . . , J) and T(Conk) (k=1, . . . , K), and the propositional variables stored in the storage device 34. The quantifier eliminating unit 331 calculates, using an algorism of QE or the like, a real number logical formula yr equivalent to this logical formula (Expression 9) and not including a quantifier. In other words, the quantifier eliminating unit 331 converts Expression 9 into an equivalent real number logical formula equivalent to Expression 9 and including no quantifier.

The logical formula simplifying unit 332 calculates a logical formula ψ′ that is equivalent to the logical formula ψ and more simplified (step C4). Specifically, since this logical formula ψ is sometimes expressed redundantly, the logical formula simplifying unit 332 converts this logical formula W not including a quantifier into the logical formula ψ′ that is equivalent to the logical formula ψ and simpler. A conversion method into a simple logical formula may be performed by, for example, expanding the algorithm of QE. Note that the processing in C4 may not be performed. Finally, the output device 35 outputs the simplified logical formula ψ′ (step C5).

### (Explanation of Effects)

Subsequently, effects of the second example embodiment are explained. The calculating unit 33 in the second example embodiment can calculate a simplified real number logical formula not including a quantifier that determines the accurate range that conditional probabilities represented by closed terms input to the input device 31 can take. By performing two conversions of the quantifier elimination and the simplification in this way, it is possible to transform “an accurate range of values that can be taken” described in a complicated logical formula into a simpler and easier-to-understand (that is, improved in readability for human) form. Consequently, the range that the conditional probabilities represented by the closed terms input to the input device 31 can take can be transformed into a simple form such as 0≤P(A|B)≤⅓.

Note that the calculating unit 33 may not include the logical formula simplifying unit 332. In this case, the calculating unit 33 outputs a real number logical formula not simplified and not including a quantifier. In this way, even with only the conversion of the quantifier elimination, it is possible to convert “an accurate range of values that can be taken” described in a complicated logical formula into a simpler and easier-to-understand (that is, improved in readability for human) form.

Note that, since the output in the first example embodiment is the “evaluation” of the range that the conditional probabilities can take, the range of values that can be taken is “evaluated” from the “inner side” and the “outer side”. That is, in the first example embodiment, the accurate range that the conditional probabilities can take is not obtained. In contrast, in the second example embodiment, the accurate region is given like 0≤p(lung cancer|colon cancer)≤⅓.

Note that the region is sometimes represented by an inequality between polynomials as indicated by, for example, the following Expression 10.

[Math. 10]

5p(lung cancer|colon cancer)²−5p(lung cancer|colon cancer)+1≤0 (10)

In this case, the method according to the first example embodiment can be more advantageous in terms of easiness of intuitive understanding.

Note that, as explained above, the logical formula (Expression 9) in the stage before the quantifier elimination is performed, can give the accurate region of the conditional probabilities represented by the closed terms input to the input device 31. Then, the two conversions of the quantifier elimination and the simplification perform the transformation equivalent to Expression 9. Therefore, the final result can also give the accurate region of the range of values that the conditional probabilities can take.

Note that, as explained above, Expression 9 can give the accurate region (range) of the conditional probabilities but, on the other hand, is hard to understand for human and poor in readability. In contrast, the method according to the first example embodiment is configured to be mathematically correct in terms of “evaluation” and see a true value on the premise of any accuracy, by evaluating, with any accuracy, the range of values that the conditional probabilities can take. In other words, the first example embodiment is not premised on accuracy of the region (range) of values that the conditional probabilities can take. In contrast, in the second example embodiment, since the transformation equivalent to Expression 9 is performed, it is possible to obtain a result readable for human as much as possible while keeping accuracy of the range of values that the conditional probabilities can take.

### Third Example Embodiment

Subsequently, the third example embodiment of the present disclosure is explained with reference to the drawings. In the third example embodiment, (Boolean connection, that is, connection by Boolean connectives of) the inequality between the polynomials output in the second example embodiment is further processed and the region defined by (the Boolean connection of) the inequality is illustrated.

(Explanation of a configuration)

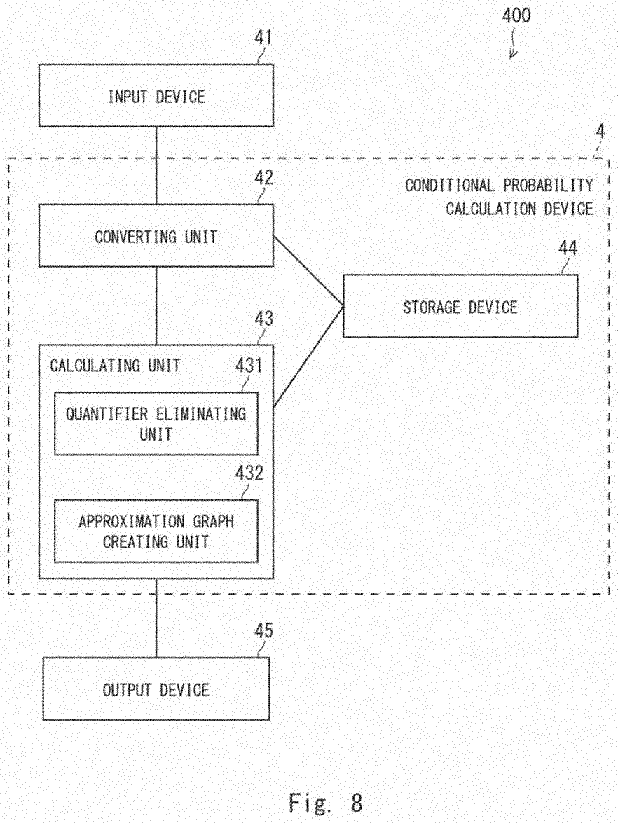

FIG. 8 is a block diagram showing an information processing system 400 according to the third example embodiment. As shown in FIG. 8, the information processing system 400 according to the third example embodiment includes a conditional probability calculation device 4, an input device 41, and an output device 45. The conditional probability calculation device 4 according to the third example embodiment includes a converting unit 42, a calculating unit 43, and a storage device 44. The converting unit 42 is connected to the input device 41, the calculating unit 43, and the storage device 44. The calculating unit 43 is connected to the converting unit 42, the storage device 44, and the output device 45. The calculating unit 43 includes a quantifier eliminating unit 431 and an approximation graph creating unit 432. Referring to FIG. 8, the calculating unit 43 according to the third example embodiment is different from the calculating unit 33 according to the second example embodiment. The calculating unit 43 includes the quantifier eliminating unit 431 and the approximation graph creating unit 432 and does not include the logical formula simplifying unit 332. The other components in the third example embodiment are substantially the same as the components in the second example embodiment.

The components of the conditional probability calculation device 4 respectively schematically operate as explained below. First, the input device 41 and the converting unit 42 are the same as the input device 11 and the converting unit 12 and perform the same operations as the operations of the input device 11 and the converting unit 12. That is, the operations of the components other than the calculating unit 43 are substantially the same as the operations of the components in the first example embodiment. The approximation graph creating unit 432 creates an approximation graph that graphically displays a range of values that a conditional probability group can take. The approximation graph represents the range of values that a real number variable group can take, with a real number logical formulas obtained by converting conditional probability definition formulas and logical formulas representing probability information, as constraint conditions.

### (Explanation of an Operation)

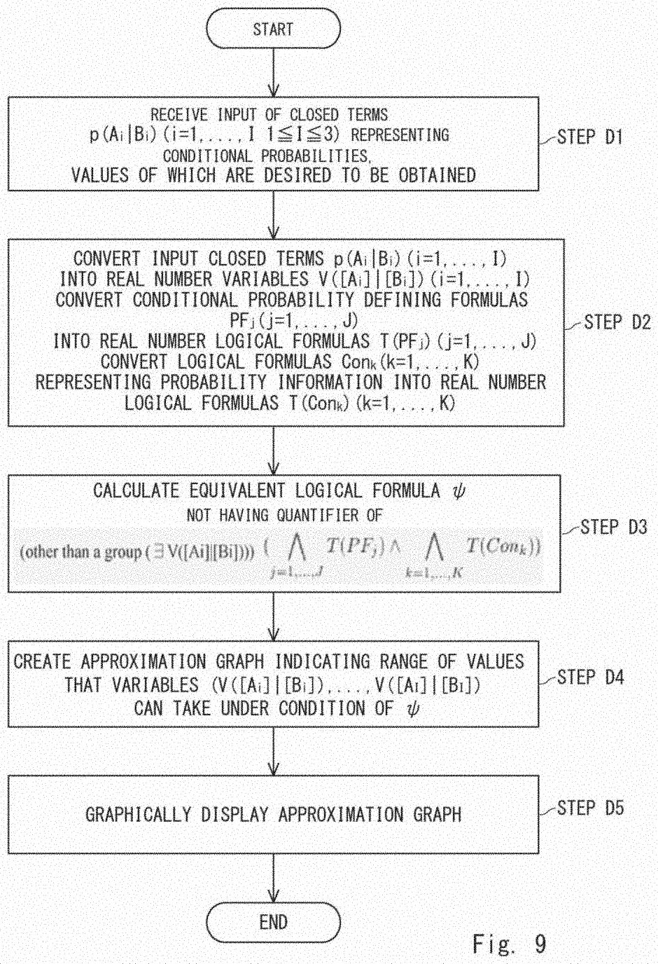

FIG. 9 is a flowchart showing the operation of the information processing system 400 according to the third example embodiment. First, the input device 41 receives an input of closed terms p(Ai|Bi) (i=1, . . . , I) representing one or more and three or less conditional probabilities, values of which are desired to be obtained (step D1). That is, 1≤I≤3. I corresponds to a dimension number in graphically displaying a range of values that conditional probabilities can take. That is, by setting I as 1≤I≤3 (equal to or smaller than three dimensions), it is possible to perform graphics display of the range of values that the conditional probabilities can take.

The converting unit 42 is substantially the same as the converting unit 12 in the first example embodiment. Therefore, the converting unit 42 performs substantially the same processing as step A2 (step D2). Subsequently, the quantifier eliminating unit 431 is the same as the quantifier eliminating unit 331 in the second example embodiment. Therefore, the quantifier eliminating unit 431 performs substantially the same processing as step C3 (step D3).

A logical formula output in step D3 is, for example, like the following expression, a logical formula obtained by connecting, with a Booleans connective such as Λ or ¬, equalities or inequalities between polynomials the concerning real number variables obtained by converting closed terms representing input conditional probabilities.

[Math. 11]

V([A]|[B])²≤V([C]|[B])∧V([C]|[B])≤V([A]|[B]) (11)

Note that, in Expression 11, the real number variables obtained by converting the closed terms representing the conditional probability corresponds to “V([A]|[B])” and “V([C]|[B])” respectively obtained by converting p(A|B) and p(C|B).

Subsequently, the approximation graph creating unit 432 creates an approximation graph such that the region decided by this logical formula can be graphically output (step D4). That is, the approximation graph creating unit 432 creates an approximation graph showing the range of values that variables (V([Ai]|[Bi]), . . . , V([AI]|[BI]) can take under the condition of ψ. Subsequently, the output device 45 graphically outputs the obtained approximation graph (step D5).

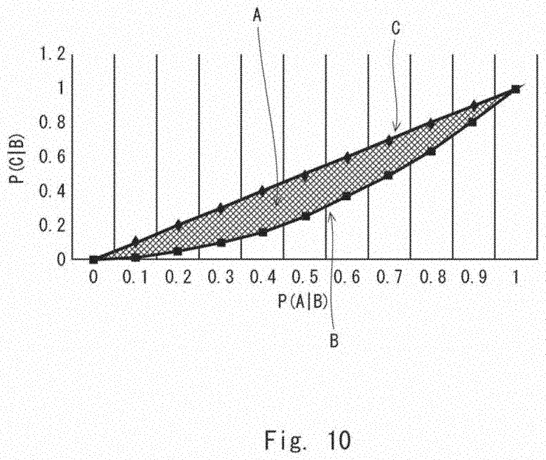

FIG. 10 is a diagram illustrating an approximation graph according to the third example embodiment. FIG. 10 is an example in which the boundary of Expression 11 is approximated by a line graph. A hatched region (indicated by an arrow A) including the boundary is a region defined by Expression 11. The curved line on the lower side indicated by the arrow B corresponds to “V([C]|[B])=V([A]|[B])²”. Therefore, the first inequality of Expression 11 defines a region above the curved line on the lower side. On the other hand, the straight line on the upper side indicated by the arrow C corresponds to V([C]|[B])=V([A]|[B]). Therefore, the second inequality of Expression 11 defines the region on the lower side than the straight line on the upper side. Expression 11, which is the conjunction of the inequality in the former half and the inequality in the latter half, defines the intersection of these two regions.

### (Explanation of Effects)

Subsequently, effects of the third example embodiment are explained. The calculating unit 43 according to the third example embodiment can obtain an approximation graph showing the range of values that conditional probabilities represented by input closed terms can take. Consequently, it is possible to visually grasp a schematic (approximation) of the range of values that the conditional probabilities represented by the input closed terms can take. Note that, in order to enable the visual grasping, the range of values that the conditional probabilities can take according to the third example embodiment can be inferior in accuracy to the range of values that the conditional probabilities can take according to the second example embodiment.

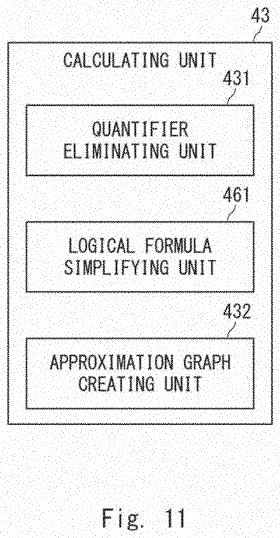

FIG. 11 is a diagram showing a modification of the calculating unit 43 according to the third example embodiment. In the third example embodiment, as shown in FIG. 11, the calculating unit 43 may further include a logical formula simplifying unit 461. In this case, the quantifier eliminating unit 431 transforms Expression 9 into an equivalent logical formula not including a quantifier (step D3). Further, the logical formula simplifying unit 461 simplifies the logical formula (see step C4). The approximation graph creating unit 432 creates an approximation graph of the region decided by the simplified logical formula. However, since the simplified logical formula and the logical formula before the simplification not including a quantifier are equivalent, when the calculating unit 43 includes the logical formula simplifying unit 461 (FIG. 11) and when the calculating unit 43 does not include the logical formula simplifying unit 461 (FIG. 8), output regions (ranges) are the same.

### Fourth Example Embodiment

Subsequently, a fourth example embodiment is explained.

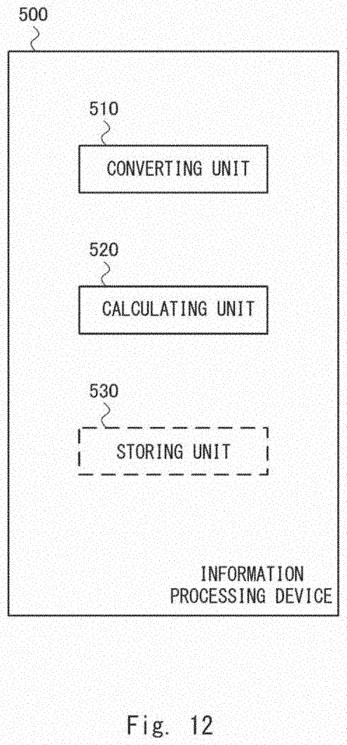

FIG. 12 is a diagram showing an information processing device 500 according to the fourth example embodiment. The information processing device 500 has a function of a computer. The information processing device 500 includes a converting unit 510 functioning as converting means and a calculating unit 520 functioning as calculating means. The converting unit 510 can be realized by substantially the same function as the function of the converting units in the example embodiments explained above. The calculating unit 520 can be realized by substantially the same function as the function of the calculating units in the example embodiments explained above.

Note that the information processing device 500 may include a storing unit 530 functioning as storing means. The storing unit 530 may store a propositional variable group used in conversion. As in the example embodiments explained above, the converting unit 510, the calculating unit 520, and the storing unit 530 may be realized by a CPU included in the information processing device 500 executing a program.

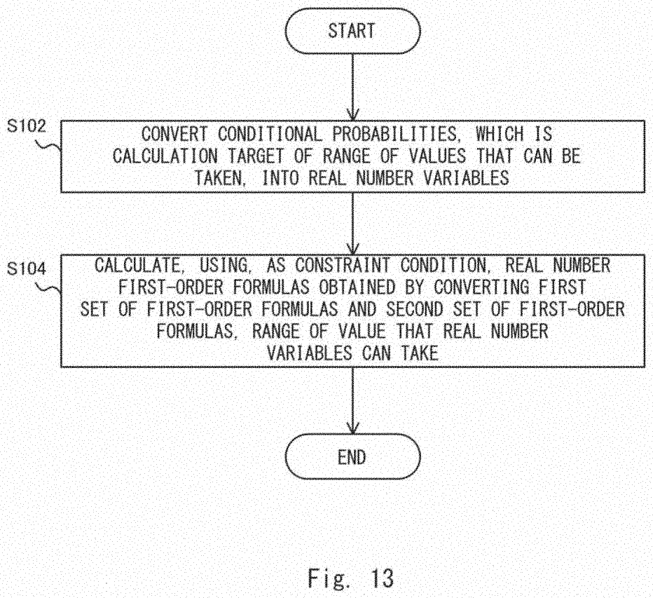

FIG. 13 is a flowchart showing an information processing method executed by the information processing device 500 according to the fourth example embodiment. The converting unit 510 converts conditional probabilities, which are the calculation target of the range of values that can be taken, int real number variables (step S102). “Conditional probabilities, which are the calculation target of the range of values that can be taken” corresponds to “(the closed terms representing) conditional probabilities, values of which are desired to be obtained” in step A1 and the like explained above.

The calculating unit 520 calculates, using, as constraint conditions, the real number first-order formulas obtained by converting first set of first-order formulas and second set of first-order formulas, the of values that the real number variables converted in S102 can take (step S104). The “first set of first-order formulas” corresponds to the “conditional-probability-defining formulas” explained above. Therefore, the first set of first-order formulas characterizes a function of receiving a pair of propositional formulas and returning the conditional probability between the events represented by the pair. The “second set of first-order formulas” corresponds to the “logical formulas representing probability information” explained above. Therefore, the second set of first-order formulas represents at least one of the known value of a conditional probability and a mutual relation of conditional probabilities.

The “converted real number first-order formulas” corresponds to the real number logical formula group after the conversion explained above. As in the example embodiments explained above, the “converted real number first-order formulas” may be acquired by the converting unit 510 converting the first set of first-order formulas and the second set of first-order formulas. Alternatively, the “converted real number first-order formulas” may be stored in the storing unit 530 in advance. That is, it is unnecessary to convert the first set of first-order formula and the second set of first-order formula into real number first-order formulas every time the processing is executed. The same applies in the example embodiments explained above.

The calculating unit 520 may calculate, according to a method substantially the same as the method used by the calculating unit 13 according to the first example embodiment, the range of values that real number variables can take. Therefore, the calculating unit 520 may evaluate, with designated accuracy, the range of values that the real number variables can take at the time when the real number first-order formulas is set as constraint conditions. At this time, the calculating unit 520 may perform the evaluation of the range by determining the truth value of real number closed logical formula concerning the range of values that the real number variables can take at the time when the real number first-order formulas are set as the constraint conditions.

The calculating unit 520 may calculate, according to a method substantially the same as the method used by the calculating unit 33 according to the second example embodiment, the range of values that real number variables can take. Therefore, the calculating unit 520 may calculate, from the real number logical formulas defining the range of values that the real number variables can take at the time when the real number first-order formulas are set as the constraint conditions, a real number first-order formula not including a quantifier and more simplified than the real number logical formula. The calculating unit 520 may calculate, according to a method substantially the same as the method used by the calculating unit 43 according to the third example embodiment, the range of values that real number variables can take. Therefore, the calculating unit 520 may create a graph (an approximation graph) representing the range of values that the real number variables can take at the time when the real number first-order formulas are set as constraint conditions.

Since the information processing device 500 according to the fourth example embodiment is configured as explained above, it is possible to surely calculate, from at least one of the known value of a conditional probability and a mutual relation of conditional probabilities, the range of values that the designated conditional probabilities can take. Note that, when an information processing method executed by the information processing device 500 and a program for executing the information processing method are used, it is also possible to surely calculate, from at least one of the known value of a conditional probability and a mutual relation of conditional probabilities, the range of values that designated conditional probabilities can take.

### (Modifications)

Note that the present invention is not limited to the example embodiments explained above and can be changed as appropriate in a range not departing from the gist of the present invention. For example, one or more of the kinds of processing of the steps of the flowcharts explained above can be omitted. The order of the steps of the flowcharts explained above can be changed as appropriate. For example, the order of step A4 and step A5 of FIG. 2 may be opposite. Similarly, the order of step B4 and step B5 of FIG. 4 may be opposite.

In the example explained above, the program can be stored using non-transitory computer-readable media of various types and supplied to the computer. The non-transitory computer-readable media include tangible storage media of various types. Examples of the non-transitory computer-readable media include magnetic recording media (for example, a flexible disk, a magnetic tape, and a hard disk drive), magneto-optical recording media (for example, a magneto-optical disk), a CD-ROM, a CD-R, a CD-R/W, and semiconductor memories (for example, a mask ROM, a PROM (Programmable ROM), an EPROM (Erasable PROM), a flash ROM, and a RAM). The program may be supplied to the computer by transitory computer-readable media of various types. Examples of the transitory computer-readable media include an electric signal, an optical signal, and an electromagnetic wave. The transitory computer-readable media can supply the program to the computer via a wired communication line such as an electric wire or an optical fiber or a wireless communication line.

The invention of the present application is explained above with reference to the example embodiments. However, the invention of the present application is not limited by the above explanation. Various changes that those skilled in the art can understand can be made to the configuration and the details of the invention of the present application within the scope of the invention.

A part or all of the example embodiments explained above can be described as indicated by the following supplementary notes but are not limited by the following.

### (Supplementary Note 1)

An information processing device comprising:

converting means for converting conditional probabilities, which is a calculation target of a range of values that can be taken, into real number variables; and

calculating means for calculating, using, a constraint conditions, real number first-order formulas obtained by converting a first set of first-order formulas for characterizing a function for receiving a pair of propositional formulas and returning conditional probabilities between events represented by the pair and a second set of first-order formulas representing at least one of a known value of a conditional probability and a mutual relation of conditional probabilities, a range of values that the real number variables can take.

### (Supplementary Note 2)

The information processing device according to Supplementary Note 1, wherein the first set of first-order formulas and the second set of first-order formulas are allowed to have content expressed using Boolean connectives and quantifiers with respect to inequalities and equalities between higher-order polynomials that can be expressed by conditional probability logical formulas.

### (Supplementary Note 3)

The information processing device according to Supplementary Note 1 or 2, further comprising storing means for storing propositional variables used in the conversion.

### (Supplementary Note 4)

The information processing device according to any one of Supplementary Notes 1 to 3, wherein the calculating means evaluates, with designated accuracy, the range of values that the real number variables can take at a time when the real number first-order formulas are set as the constraint conditions.

### (Supplementary Note 5)

The information processing device according to Supplementary Note 4, wherein the calculating means performs the evaluation of the range by determining the truth value of a real number closed logical formula concerning the range of values that the real number variables can take at the time when the real number first-order formulas are set as the constraint conditions.

### (Supplementary Note 6)

The information processing device according to any one of Supplementary Notes 1 to 3, wherein the calculating means calculates, from real number logical formulas defining the range of values that the real number variables can take at a time when the real number first-order formulas are set as the constraint conditions, a real number first-order formula not including a quantifier and more simplified than the real number logical formula.

### (Supplementary Note 7)

The information processing device according to any one of Supplementary Notes 1 to 3, wherein the calculating means creates a graph representing the range of values that the real number variables can take at a time when the real number first-order formulas are set as the constraint conditions.

### (Supplementary Note 8)

An information processing method comprising:

converting conditional probabilities, which are a calculation target of the range of values that can be taken, into real number variables; and

calculating, using, as constraint conditions, real number first-order formulas obtained by converting a first set of first-order formulas for characterizing a function for receiving a pair of propositional formulas and returning conditional probabilities between events represented by the pair and a second set of first-order formula group representing at least one of a known value of conditional probability and a mutual relation of conditional probabilities, a range of values that the real number variables can take.

### (Supplementary Note 9)

The information processing method according to Supplementary Note 8, wherein the first set of first-order formulas and the second set of first-order formulas are allowed to have content expressed using Boolean connectives and quantifiers with respect to inequalities and equalities between higher-order polynomials that can be expressed by conditional probability logical formulas.

### (Supplementary Note 10)

The information processing method according to Supplementary Note 8 or 9, wherein propositional variables used in the conversion is stored.

### (Supplementary Note 11)

The information processing method according to any one of Supplementary Notes 8 to 10, further comprising evaluating, with designated accuracy, the range of values that the real number variables can take at a time when the real number first-order formulas are set as the constraint conditions.

### (Supplementary Note 12)

The information processing method according to Supplementary Note 11, further comprising performing the evaluation of the range by determining truth value of a real number closed logical formula concerning the range of values that the real number variables can take at the time when the real number first-order formulas are set as the constraint condition.

### (Supplementary Note 13)

The information processing method according to any one of Supplementary Notes 8 to 10, further comprising calculating, from a real number logical formula defining the range of values that the real number variables can take at a time when the real number first-order formulas are set as the constraint conditions, a real number first-order formula not including a quantifier and more simplified than the real number logical formula.

### (Supplementary Note 14)

The information processing method according to any one of Supplementary Notes 8 to 10, further comprising creating a graph representing the range of values that the real number variables can take at a time when the real number first-order formulas are set as the constraint conditions.

### (Supplementary Note 15)

A non-transitory computer-readable medium storing a program for causing a computer to execute:

processing for converting a conditional probability group, which is a calculation target of a range of values that can be taken, into real number variables; and

processing for calculating, using, as constraint conditions, real number first-order formulas obtained by converting a first set of first-order formulas for characterizing a function for receiving a pair of propositional formulas and returning conditional probabilities between events represented by the pair and a second set of first-order formulas representing at least one of a known value of a conditional probability and a mutual relation of conditional probabilities, a range of values that the real number variables can take.

### (Supplementary Note 16)

The non-transitory computer-readable medium storing the program according to Supplementary Note 15, wherein the first set of first-order formulas and the second set of first-order formulas are allowed to have content expressed using Boolean connectives and quantifiers with respect to inequalities and equalities between higher-order polynomials that can be expressed by conditional probability logical formulas.

### (Supplementary Note 17)

The non-transitory computer-readable medium storing the program according to Supplementary Note 15 or 16, wherein propositional variables used in the conversion is stored.

### (Supplementary Note 18)

The non-transitory computer-readable medium storing the program according to any one of Supplementary Notes 15 to 17, further causing the computer to execute processing for evaluating, with designated accuracy, the range of values that the real number variables can take at a time when the real number first-order formulas are set as the constraint conditions.

### (Supplementary Note 19)

The non-transitory computer-readable medium storing the program according to Supplementary Note 18, further causing the computer to execute processing for performing the evaluation of the range by determining truth value of a real number closed logical formula concerning the range of values that the real number variables can take at the time when the real number first-order formulas are set as the constraint conditions.

### (Supplementary Note 20)

The non-transitory computer-readable medium storing the program according to any one of Supplementary Notes 15 to 17, further causing the computer to execute processing for calculating, from a real number logical formula defining the range of values that the real number variables can take at a time when the real number first-order formulas are set as the constraint conditions, a real number first-order formula not including a quantifier and more simplified than the real number logical formula.

### (Supplementary Note 21)

The non-transitory computer-readable medium storing the program according to any one of Supplementary Notes 15 to 17, further causing the computer to execute processing for creating a graph representing the range of values that the real number variables can take at a time when the real number first-order formulas are set as the constraint conditions.

### INDUSTRIAL APPLICABILITY

The present invention can be used for, for example, an analysis concerning medical treatment and a weather forecast.

### REFERENCE SIGNS LIST

100 INFORMATION PROCESSING SYSTEM
1 CONDITIONAL PROBABILITY CALCULATION DEVICE
11 INPUT DEVICE
12 CONVERTING UNIT
13 CALCULATING UNIT
14 STORAGE DEVICE
15 OUTPUT DEVICE
131 TRUTH VALUE DETERMINING UNIT
200 INFORMATION PROCESSING SYSTEM
2 CONDITIONAL PROBABILITY CALCULATION DEVICE
21 INPUT DEVICE
22 CONVERTING UNIT
23 CALCULATING UNIT
24 STORAGE DEVICE
25 OUTPUT DEVICE
231 TRUTH VALUE DETERMINING UNIT
300 INFORMATION PROCESSING SYSTEM
3 CONDITIONAL PROBABILITY CALCULATION DEVICE
31 INPUT DEVICE
32 CONVERTING UNIT
33 CALCULATING UNIT
34 STORAGE DEVICE
35 OUTPUT DEVICE
331 QUANTIFIER ELIMINATING UNIT
332 LOGICAL FORMULA SIMPLIFYING UNIT
400 INFORMATION PROCESSING SYSTEM
4 CONDITIONAL PROBABILITY CALCULATION DEVICE
41 INPUT DEVICE
42 CONVERTING UNIT
43 CALCULATING UNIT
44 STORAGE DEVICE
45 OUTPUT DEVICE
431 QUANTIFIER ELIMINATING UNIT
432 APPROXIMATION GRAPH CREATING UNIT
461 LOGICAL FORMULA SIMPLIFYING UNIT
500 INFORMATION PROCESSING DEVICE
510 CONVERTING UNIT
520 CALCULATING UNIT
530 STORING UNIT

What is claimed is:

1. An information processing device comprising:
hardware, including a processor and memory;
converting unit implemented at least by the hardware and configured to convert conditional probabilities, which is a calculation target of a range of values that can be taken, into real number variables; and
calculating unit implemented at least by the hardware and configured to calculate a range of values of the real number variables using constraint conditions indicating real number first-order formulas obtained by converting a first set of first-order formulas and a second set of first-order formulas, the first set of first-order formula group characterizing a function for receiving a pair of propositional formulas and returning conditional probabilities between events represented by the pair and the second set of first-order formulas representing at least one of a known value of a conditional probability and a mutual relation of conditional probabilities.

2. The information processing device according to claim 1, wherein the first set of first-order formulas and the second set of first-order formulas are allowed to have content expressed using Boolean connectives and quantifiers with respect to inequalities and equalities between higher-order polynomials that can be expressed by conditional probability logical formulas.

3. The information processing device according to claim 1, further comprising unit implemented at least by the hardware and configured to store propositional variables used in the conversion.

4. The information processing device according to claim 1, wherein the calculating unit evaluates, with designated accuracy, the range of values that the real number variables can take at a time when the real number first-order formulas are set as the constraint conditions.

5. The information processing device according to claim 4, wherein the calculating unit performs the evaluation of the range by determining truth value of a real number closed logical formula concerning the range of values that the real number variables can take at the time when the real number first-order formulas are set as the constraint conditions.

6. The information processing device according to claim 1, wherein the calculating unit calculates, from a real number logical formula defining the range of values that the real number variables can take at a time when the real number first-order formulas are set as the constraint conditions, a real number first-order formula not including a quantifier and more simplified than the real number logical formula.

7. The information processing device according to claim 1, wherein the calculating unit creates a graph representing the range of values that the real number variables can take at a time when the real number first-order formulas are set as the constraint condition.

8. An information processing method comprising:
converting conditional probabilities, which is a calculation target of a range of values that can be taken, into real number variables; and
calculating a range of values of the real number variables using constraint conditions indicating real number first-order formulas obtained by converting a first set of first-order formulas and a second set of first-order formulas, the first set of first-order formula group characterizing a function for receiving a pair of propositional formulas and returning conditional probabilities between events represented by the pair and the second set of first-order formulas representing at least one of a known value of a conditional probability and a mutual relation of conditional probabilities.

9. The information processing method according to claim 8, wherein the first set of first-order formulas and the second set of first-order formulas are allowed to have content expressed using Boolean connectives and quantifiers with respect to inequalities and equalities between higher-order polynomials that can be expressed by conditional probability logical formulas.

10. The information processing method according to claim 8, wherein propositional variables used in the conversion are stored.

11. The information processing method according to claim 8, further comprising evaluating, with designated accuracy, the range of values that the real number variables can take at a time when the real number first-order formulas are set as the constraint conditions.

12. The information processing method according to claim 11, further comprising performing the evaluation of the range by determining the truth value of a real number closed logical formula concerning the range of values that the real number variable group can take at the time when the real number first-order formulas are as the constraint condition.

13. The information processing method according to claim 8, further comprising calculating, from a real number logical formula defining the range of values that the real number variables can take at a time when the real number first-order formulas are set as the constraint conditions, a real number first-order formula not including a quantifier and more simplified than the real number logical formula.

14. The information processing method according to claim 8, further comprising creating a graph representing the range of values that the real number variables can take at a time when the real number first-order formulas are set as the constraint conditions.

15. A non-transitory computer-readable medium storing a program for causing a computer to execute:
processing for converting conditional probabilities, which is the calculation target of a range of values that can be taken, into real number variables; and
processing for calculating a range of values of the real number variables using constraint conditions indicating real number first-order formulas obtained by converting a first set of first-order formulas and a second set of first-order formulas, the first set of first-order formula group characterizing a function for receiving a pair of propositional formulas and returning conditional probabilities between events represented by the pair and the second set of first-order formulas representing at least one of known value of a conditional probability and a mutual relation of conditional probabilities.

16. The non-transitory computer-readable medium storing the program according to claim 15, wherein the first set of first-order formulas and the second set of first-order formulas are allowed to have content expressed using Boolean connectives and quantifiers with respect to inequalities and equalities between higher-order polynomials that can be expressed by conditional probability logical formulas.

17. The non-transitory computer-readable medium storing the program according to claim 15, wherein propositional variables used in the conversion is stored.

18. The non-transitory computer-readable medium storing the program according to claim 15, further causing the computer to execute processing for evaluating, with designated accuracy, the range of values that the real number variables can take at a time when the real number first-order formulas are set as the constraint condition.

19. The non-transitory computer-readable medium storing the program according to claim 18, further causing the computer to execute processing for performing the evaluation of the range by determining the truth value of a real number closed logical formula concerning the range of values that the real number variables can take at the time when the real number first-order formulas are set as the constraint conditions.

20. The non-transitory computer-readable medium storing the program according to claim 15, further causing the computer to execute processing for calculating, from a real number logical formula defining the range of values that the real number variables can take at a time when the real number first-order formulas are set as the constraint condition, a real number first-order formula not including a quantifier and more simplified than the real number logical formula.

21. (canceled)
